(19) United States
(12) Patent Application Publication
(10) Pub. No.: US 2019/0139153 A1
(43) Pub. Date: May 9, 2019

(54) METHOD AND SYSTEM FOR ANALYSING, IMPROVING, AND MONITORING THE CO-PROSPERITY OF NETWORKS

(71) Applicant: Alan William Howe Grant, Trenton (CA)

(72) Inventor: Alan William Howe Grant, Trenton (CA)

(21) Appl. No.: 16/182,304

(22) Filed: Nov. 6, 2018

Related U.S. Application Data
(60) Provisional application No. 62/582,096, filed on Nov. 6, 2017.

(51) Int. Cl. G06Q 50/00; G06N 99/00; G06N 5/02; H04L 29/08

(52) U.S. Cl. CPC G06Q 50/01; H04L 67/22; G06N 5/022; G06N 99/005

(57) ABSTRACT

Methods and systems for analyzing, improving, and monitoring the co-prosperity of members of a network, an ego network, a subnetwork or affiliated networks, implement the steps of: for each member, profiling the habits of the member and determining a member habit index; profiling the welfare and wellbeing of the member and determining a member success index; determining a co-prosperity index for the member reflecting the member's benefits from and contributions to the network; determining the causal relationships between the member and network relationship habit profiles and the co-prosperity index of the member; developing and delivering a habit improvement program to the member based on the predictive modelling of the impact of changes to the member habit profile and the member welfare and wellbeing outcomes. The method and system may track the effectiveness of the habit improvement program by periodically updating the habit profile of the member and the welfare and wellbeing profile of the member.

### TECHNICAL FIELD

The present invention is related to the field of analysis and prosperity improvement of individual and organizational ego networks, in particular, artificial intelligence systems and methods to aid in improving the outcomes of human combinations in personal and organizational ego networks by using expert advisory systems to perform network sociometric analysis and habit improvement.

### BACKGROUND

In recent years, a great deal of focus has been placed on the expanding connections and communications between large numbers of individuals participating in digital “social networks”. It is not uncommon for these social networks to connect thousands or even many millions of individuals. These social networks do not center on any single individual or corporate entity. FIG. 1 shows a mapping of the connections between the individuals in a specific social network. This map shows how the connection between any two individuals may be direct and only have one tie, or can be very indirect, involving between two and six ties, these multi-step indirect connections referred to as “degrees of separation. Research has shown how it is uncommon to have more than “six degrees of separation” between the members of even very expansive social networks.

However, the basic building blocks of our overall human social network are the interlocking “ego networks” of the underlying individuals. These personal ego networks are defined by the ties between each of us (“ego”) and all of the important other people (“alters”) at we each directly connect with in our lives. In contrast to social networks, in an ego network there is never more than one tie separating the ego from all of the alters. Our ego network is more commonly be referred to as our direct “social circle”.

Our overall personal ego networks are comprised of a combination of sub networks ranging in size from simple bi-lateral relationships (with our spouses, children, etc.) to various larger multi-lateral sub networks (our workplace groups, community groups, etc.).

An example of a personal ego network (showing the ties between the ego and all of its alters as well as any ties between the alters) is shown in FIG. 2. Unlike the relationships with most of our broader social network “friends”, the parties in our ego network are particularly important because the relationship habits the network members adopt when they combine with their counterparties creates a group dynamic that can produce widely varying successful or unsuccessful welfare and wellbeing (“prosperity”) outcomes for network members involved.
If networks have synergistic group dynamics then the prosperity outcomes for all members will increase. In other words, the members and network principal will co-prosper.
If networks have additive group dynamics then the combined prosperity outcomes for all members will remain the same.
Finally, if networks have antagonistic group dynamics then the network members will reduce their total welfare and wellbeing and at least one of the members will experience a reduced level of combined prosperity.

Whenever individual members are combined into a network, there is a co-prosperity outcome for each member. Whether or not we choose to intentionally monitor, understand or manage these network dynamics and outcomes, they are nevertheless at work behind the scenes determining the levels of success and prosperity we experience in our lives at any particular point in time.

Every inanimate “corporation” also has an organizational ego network which is made up of many subnetworks which are commonly referred to as divisions, departments, teams or groups. While a personal ego network might have dozens of subnetworks, the organizational ego network of a large company could have hundreds or even thousands of subnetworks. Every organization also faces an organizational ego network sociometric analysis challenge that is completely analogous to the personal ego network sociometry challenge just outlined for their human counterparts. Not surprisingly, most corporations have either a formal or informal focus on improving the performance outcomes of their overall organizational ego network by improving the “team working” habits of their employees in the various subnetworks. Only a few employers are even starting to use the information in their internal email and messaging databases to map this organizational ego network and understand the patterns of connection between the employees within and across their various work groups/networks. An example of a corporate ego network is also shown in FIG. 2.

To date virtually all network analysis methods and systems have been focused on supporting the “social network analysis” (SNA). This field is focused solely on the analysis of multi-party social networks from the standpoint of ALL participants. This SNA analysis has been primarily focused merely on mapping and analyzing the number and nature of the specific types of connections (“ties”) between the parties largely in order to understand and enhance the parties' access to information.

In contrast, there has been little effort directed towards mapping, understanding and improving the dynamics or prosperity outcomes of personal and organizational ego networks; in other words, the practice of ego network analysis (ENA). Unlike SNA, the focus of personal and organizational ENA is to understand the individual habits, group dynamics and resulting prosperity outcomes that result when individuals are combined together into a network. In sociology, this type of general group analysis is referred to as sociometry. In mathematics, this general group analysis would be considered a component of game theory analysis. However there is currently virtually no in-depth academic research, published literature or technology tools available to help individuals and organizations understand, analyze or improve the dynamics and prosperity outcomes of their ego networks. The few software tools that are available merely help users to visually map the parties and connections in their personal or organizational ego networks. The LinkedIn™ utility that generated the ego networks in FIG. 2 is an example of such a tool. However, these applications are focused simply on creating graphic visual depictions of the ego network. They have no or limited capabilities to understand the network dynamics, measure prosperity outcomes, identify improvement priorities and implement the required habit improvement programs.

There are also various service providers (personal psychologists, performance coaches, etc.) involved in providing advisory services related to the improvement of certain dimensions of the personal ego networks. However, virtually none of these service providers use any level of empirical ego network sociometric analysis in formulating their recommended improvements. Furthermore, many of these service providers are focused on improving certain narrow network performance outcomes for the ego (such as personal physical stress levels or mental happiness) which are simply component parts of overall prosperity of the individual ego. In addition, the personal prosperity improvement advice provided by these various service providers and wellbeing-related technology applications are largely or completely based on ad hoc theories and methods which lack empirical justification.

There is also a range of proposed solutions for improving the prosperity outcomes for specific sub-networks within an individual's overall personal ego network. For example, there are point solutions offered to create positive marriage or parenting relationship outcomes. However, these solutions also have the same limitations as noted above.

Similarly, there is currently no comprehensive sociometric approach to improving the prosperity outcomes of the organizational ego networks. The available organizational ENA tools are simply focused on mapping the connections in organizational ego networks to understand the ties within and between various network members. This analysis of the specific types of connections or ties between the members is primarily focused merely on understanding and enhancing the members access to information or the cooperation between groups. These solutions have limited or no capability to understand the network dynamics or to measure or improve the employee's or employer's prosperity outcomes.

Various ad hoc efforts have been invested on the narrower challenge of improving the performance of employee work groups. Invariably, these solutions are focused on defining the employee behaviors that will produce better outcomes for the employer so that HR managers can determine ways of motivating the employee to exhibit these company-beneficial behaviors through traditional performance evaluation and compensation policies. These “team building” solutions are not based on empirically validated methodologies for understanding the dynamics between the relationship habits of the individual members, the implications for their group dynamics and the resulting prosperity outcomes for both the employees and employer. Also, since these systems are employer-initiated control systems, (versus an employee-driven personal improvement platform) their evaluation and reward based control mechanisms invite “gaming” of the system by individuals looking to maximize their personal gain.

The labor intensity of providing one-on-one (1:1) human counselling to corporate or personal ego network members is unaffordable given the costs of defining the personalized improvement plans, let alone the ongoing follow-up time required to support improved social habit development. However, to the Applicant's knowledge, there are no artificial intelligence based “expert systems” available to provide individuals with 1:1 relationship habit improvement advice. But this is understandable given the social relationship “soft” habit improvement advice provided by current human expert advisors is not based on the type of validated “hard” science needed to configure the algorithms of an automated expert advice software application. Therefore to date it has been impossible to power any automated expert advisory system because of the lack of an empirically validated scientific method for developing the algorithm intelligence of the system. It is, therefore, desirable to provide a method and system for analysing, improving and monitoring the co-prosperity of ego networks that may overcome the shortcomings of the prior art.

### SUMMARY

The sociometric methods and systems for analyzing, improving and monitoring the co-prosperity of members of a network described herein are intended to help organizations and individuals improve the welfare and wellbeing outcomes generated from their ego networks. The methods comprise an automated analysis of the network member behaviors and dynamics to understand the adverse and beneficial impacts of their current relationship habits, and then providing each member with empirically-validated ongoing personalized habit improvement coaching through the use of artificially intelligent expert system.

In one aspect, embodiments of the expert systems described herein employs a novel sociometric method for achieving improvement in the prosperity outcomes of individual members in a network, which may be an ego network, group of ego networks, or a subnetwork. This method is based on assessing and indexing the degree to which all members of the network adopt the relationship habits required to create a maximum “co-prospering” outcome. This expert system advisory methodology is based on the insight that groups cannot achieve their maximum level of shared success when the members unconsciously or consciously adopt either overly dependent (other-reliant) or overly independent (self-reliant) relationship habits. Only when all of the individual members of a group adopt interdependent (mutually reliant) group-working habits will the members of the group experience heightened levels of shared success. This insight provides the basis for the core predictive algorithm foundation required by any expert system. This algorithm enables the system to predict the member's likely level of benefits experienced from their work with the network and their level of contribution to the network (“Co-Prosperity Index) simply by knowing the relative proportion of the higher performing (interdependent) relationship habits practiced by all of the members in the network (Network Habit Index).

In some embodiments, as the system gains larger samples of habit and prosperity outcome data across different groups, this one-variable core predictive algorithm is refined further through structured machine learning. This refinement continuously improves the accuracy of the system forecast and provides the data needed to provide a compelling evidence-based (and self-interested) reason for group members to adopt the required (interdependent) relationship habits. The data proves that networks collectively experience a prosperity improvement from their relationship interactions when all members maximize their combined effectiveness by choosing to adopt the desired interdependent habits that raise the welfare and wellbeing (prosperity) of all members. In simple terms, embodiments of the present invention operate on the premise that greater personal success for any individual requires focusing on improving that individual's contribution to the success of others, by ensuring the member and all of their network colleagues adopt the highest performing (interdependent) relationship habits.

Team members can complete online assessment survey instruments to provide the relationship habit profiling data needed to classify group members into distinct relationship style categories. This classification data can be used to develop the numerical index of the predominant habits of each of the individual members of the network (“Member Habit Index”). By accumulating this data to produce the aggregated habit profile representative of the collective habits of the combined network, the overall network can also be assigned a specific numerical score reflective of the predominant relationship style of the network (“Network Habit Index”). These habit profiles and indices can then be each statistically correlated to an index of the prosperity outcomes of the individual network members (“Success Indices”) as well as a metric representing the co-prosperity outcome of the member (“Co-prosperity Index”).

In some embodiments, the expert system can use the habit and prosperity index data to learn the empirical relationships between various relationship habit profiles of a member and the resulting member co-prosperity outcome.

The sociometric analysis methods described herein can be implemented by an expert system to enable the automated diagnosis, analysis and improvement of the network dynamics. Diagnosis and analysis comprises the steps of determining the causal relationships between the relationship habit profiles and indices of the network members (the overall Network Habit Index) and the level of benefits the members experience from their work with the network and their level of contribution to the network. Empirically validated correlations may be established between the two data sets: the networks observed relationship habit profiles on one hand, and the member's co-prosperity outcomes on the other. The resulting correlation coefficients in these causal relationships are used to inform the automated identification of the relationship habit improvement levers with the greatest likely prosperity improvement impact.

An inventory of habit improvement interventions, which can include educational content, skill training, learning games, etc., can be aggregated in the system to use in improving the co-prospering habits of network members. The system can measure the actual pre- and post-habit improvement impacts of these various habit improvement interventions across all networks to understand their relative effectiveness in closing different types of individual relationship habit gaps. The system can use this real-time knowledge of the relative prosperity improvement effectiveness of each program to enable the automated selection (for any specific member) of the habit improvement interventions contained in the inventory of alternative habit improvement options, which are predicted to have the largest impacts.

Each network member can engage with the system through a user interface, to receive personalized relationship habit improvement advice and receive the associated highest-impact habit improvement programs. This 1-on-1 (1:1) intelligent habit improvement advice and coaching can be delivered via detailed personalized reports or through interactive engagement with a personalized intelligent software agent (“bot”). These reports and bot interactions provide the user with a highly augmented level of social intelligence. The structured learning of the system made possible by extracting statistically validated insights on the habit-outcome correlations from the accumulated in-depth data provided on/by the individuals in the network far exceeds any human-based analytic capability. This structured learning framework may allow the system to achieve a level/quality of expertise in providing 1:1 performance improvement plans and development coaching that is more effective than current traditional team building education programs and human performance coaching.

Any network member, and preferably each member, can be advanced along a pathway to greater co-prosperity by continually analyzing and improving their co-prospering habits. The expert system provides an “always on” capability to continuously monitor the habit gaps of each network member and assess the relative effectiveness of the habit improvement interventions provided to close network member habit gaps. Machine learning can be used to examine a real time database and automate the identification and delivery of the optimal ongoing habit improvement interventions that are required to continuously improve the welfare and wellbeing of each individual.

Broadly stated, in some embodiments, the invention comprises a method for analyzing, improving, and monitoring the co-prosperity of members of a network, an ego network, a subnetwork or affiliated networks, comprising the steps of: for each member, profiling the habits of the member and determining a member habit index; profiling the welfare and wellbeing of the member and determining a member success index; determining a co-prosperity index for the member reflecting the member's benefits from and contributions to the network; determining the causal relationships between the member and network relationship habit profiles and the co-prosperity index of the member; developing and delivering a habit improvement program to the member based on the predictive modelling of the impact of changes to the member habit profile and the member welfare and wellbeing outcomes. Preferably, the method further comprises the step of tracking the effectiveness of the habit improvement program by periodically updating the habit profile of the member and the welfare and wellbeing profile of the member.

Broadly stated, in some embodiments, the step of profiling the habits of the member can comprise the steps of identifying the correct core set of success-maximizing relationship habits; surveying one or more peer members on the set of core habits of the member; classifying the responses to the survey based on a set of relationship styles; calculating a member habit index (MHI) based on the relationship style classification of the survey responses from the one or more peer members; and calculating a network habit index (NHI) from the combination of the member's habit indices (MHIs). In a preferred embodiment, the MHI is calculated as the midpoint of the frequency distribution of the relationship habit classification of the survey responses. The Network Habit Index is calculated by combining and weight-averaging the MHI of the network member, the MHI of the network leader (if any) and the MHIs of all other non-group-leading group members.

Broadly stated, in some embodiments, the step of developing the welfare and wellbeing index of the member of a network can comprise the steps of selecting a set of success outcome dimensions; surveying member on the levels of benefits being experienced for each of these relationship success outcomes; and calculating a member success index based the responses to the survey questions by the member based on their current experience of their group-working success outcomes.

Broadly stated, in some embodiments, the step of correlating the habit profile of the member with the welfare and wellbeing profile of the member can be performed using multivariable regression.

Broadly stated, in some embodiments, the step of developing a habit improvement program can comprise the steps of setting a success improvement goal; determining the relative benefit improvement impact of each habit improvement option by using the database of comparable actual members behavior changes to forecast the likely impact; using scenario planning to the determine the package of from-to habit improvements with the likely greatest welfare and wellbeing impact; determining the habit improvement interventions most likely to achieve the targeted habit improvements; and presenting the habit improvement intervention to the member.

Broadly stated, in some embodiments, the habit improvement interventions can comprise one or more of educational content, skill training and learning games.

Broadly stated, in another aspect, the invention may comprise a computer system for analyzing, improving, and monitoring the co-prosperity of an ego network having a plurality of members, or a group of affiliated ego networks, the computer system comprising: at least one processor; at least one computer-readable storage medium operatively coupled to the at least one processor, said at least one computer-readable storage medium containing a representation of at least one set of computer instructions that, when executed by said processor, causes the computer system to perform the operations of: for each member, profiling the habits of the member and determining a member habit index; profiling the welfare and wellbeing of the member and determining a member success index; determining causal relationships between the member habit profile with the welfare and wellbeing profile of the member, and determining a co-prosperity index for the member from the member habit index and the member success index; developing and delivering a habit improvement program based on the causal relationships of the member habit profile and the member welfare and wellbeing profile; and tracking the effectiveness of the habit improvement program by periodically updating the habit profile of the member and the welfare and wellbeing profile of the member.

Broadly stated, in some embodiments, the operation of profiling the habits of the member can comprise: surveying one or more peer members on a set of core habits of the member; classifying the responses to the survey based on a set of relationship styles; calculating a member habit index based on the midpoint of the frequency distribution of the relationship style classification of the survey responses from the one or more peer members; and calculating a network habit index for the member based on the member's member habit index, a leader habit index, a peer habit index and network principle habit index.

Broadly stated, in some embodiments, the operation of profiling the welfare and wellbeing of the member can comprise: selecting a set of success outcomes; surveying the member on the set of success outcomes; calculating a member success index based the responses to the survey of the member based on the set of success outcomes;

Broadly stated, in some embodiments, the operation of correlating the habit profile of the member with the welfare and wellbeing profile of the member can be performed using multivariable regression.

Broadly stated, in some embodiments, the operation of developing a habit improvement program can comprise setting a success improvement goal; determining a habit improvement requirement based on the correlation of the habit profile of the member with the welfare and wellbeing profile of the member; determining a habit change required to achieve the habit improvement requirement based on scenario modeling; determining a habit improvement interventions most likely to achieve the habit change; and presenting the habit improvement intervention to the member.

Broadly stated, in some embodiments, the habit improvement interventions can comprise one or more of educational content, skill training and learning games, or other interventions demonstrated to induce habit change in at least some members.

### BRIEF DESCRIPTION OF THE DRAWINGS

FIG. 1 is a depiction of a mapping of the connections between the individuals in a specific social network.

FIG. 2 is a graphical depiction of a personal and corporate ego network.

FIG. 3 is a block diagram showing the determination of summary indices to evaluate the co-prosperity of ego networks.

FIG. 4 is an overview of the classification schema of some basic types of relationship styles of network members.

FIG. 5 is a screenshot of an expert system report showing a scatterplot array of representing real-life individual members of a specific workplace network.

FIG. 6 is a sample habit question in the automated survey application showing how the various relationship habits in any group-working situation can be arrayed (across the variously colored relationship style classification schema) in a survey application so users can record the habits they observe being used by other network members.

FIG. 7 shows how the system calculates and reports the determination of the Habit Index for the user based on the sample frequency distribution of the relationship habits derived from the responses to the peer habit survey questions.

FIG. 8 is a visual representation of two network members Member Habit Indices.

FIG. 9 is a network map showing the relationship style colors of the individual members and the Network Habit Index for each subnetworks.

FIG. 10 summarizes the welfare and wellbeing dimensions used in determining the Member Success Index of an individual user. It also shows how the survey question scores for each of these six key prosperity metrics are visually arrayed and represented to system users.

FIG. 11 is a visual mapping of a sample calculation of the Member Success Index for a particular network member.

FIG. 12 is a graph showing an example of the peer-reported perceptions of the impact of the network member on the overall network prosperity outcomes. These metrics are aggregated and averaged to create and index of the user's overall contribution to the success of the network.

FIG. 13 outlines in the callout how the member's Co-Prosperity Index is calculated for a particular network member by multiplying the level of success experienced by the network member (Member Success Index on X axis) and the level of contribution the same network member makes to the success of the overall group (Member Contribution Index on the Y axis).

FIG. 14 is a graphic representing of how a peer's assessment of a network member user impact on the network performance can be correlated to both the assessment by other network members of the user's habits as well as their willingness to refer the user to a friend or associate. In cases where complete habit survey responses cannot be completed by a user's peers, these relationship habit proxies can be used to enable quick estimation of the likely MHI and NHI.

FIG. 15 is a visual representation of a basic initial calculation of a Network Habit Index.

FIG. 16 is graph showing a sample correlation between the Network Habit Index and the Co-prosperity Index for the four quartiles of members in a particular network. This real-world data provides the evidence-based confirmation of the impact of social habit improvement on shared success outcomes needed to motivate (self-interested) user habit improvement. It gives the user an upfront estimate of the likely benefits of working on relationship habit improvements.

FIGS. 17a and 17b are a graphical representations of the process followed to identify and analyze outliers from the expected Co-Prosperity Index.

FIG. 18 is a flowchart diagram depicting one embodiment of a method used to iteratively improve the overall network Co-Prosperity Index.

FIG. 19 is a sample area chart showing the current habit mix of a network member. The user can read elaborations of the descriptions of each of the 65 relationship habits represented by the boxes in the display.

FIGS. 20, 21, 22, 23 and 24 depicts other screenshots in the summary report provided to the network member in an embodiment of the system.

FIG. 25 shows a consolidated overview of the assessment provided by the expert system by providing a summary scorecard recapping the results in each area covered previously.

FIG. 26 shows a schematic representation of one embodiment of a system described herein.

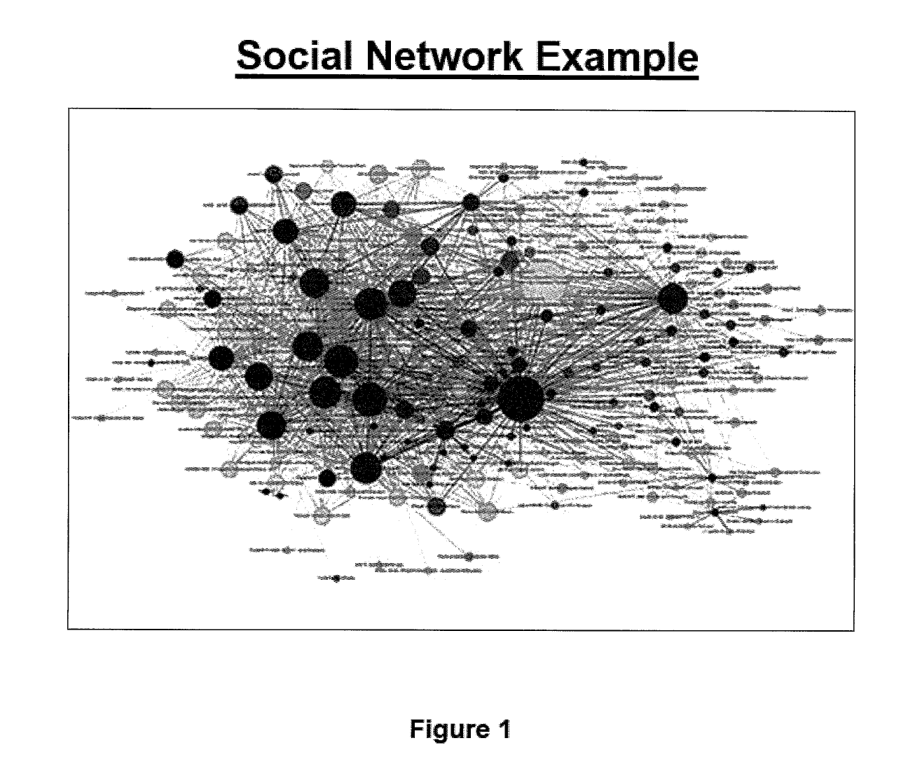

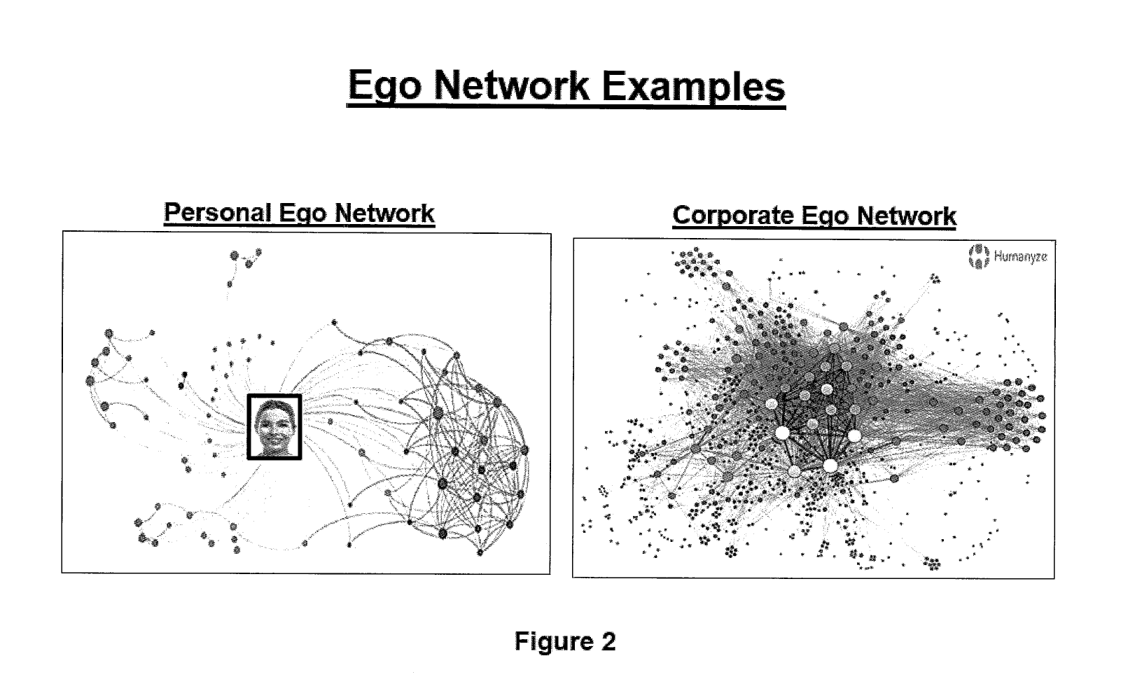

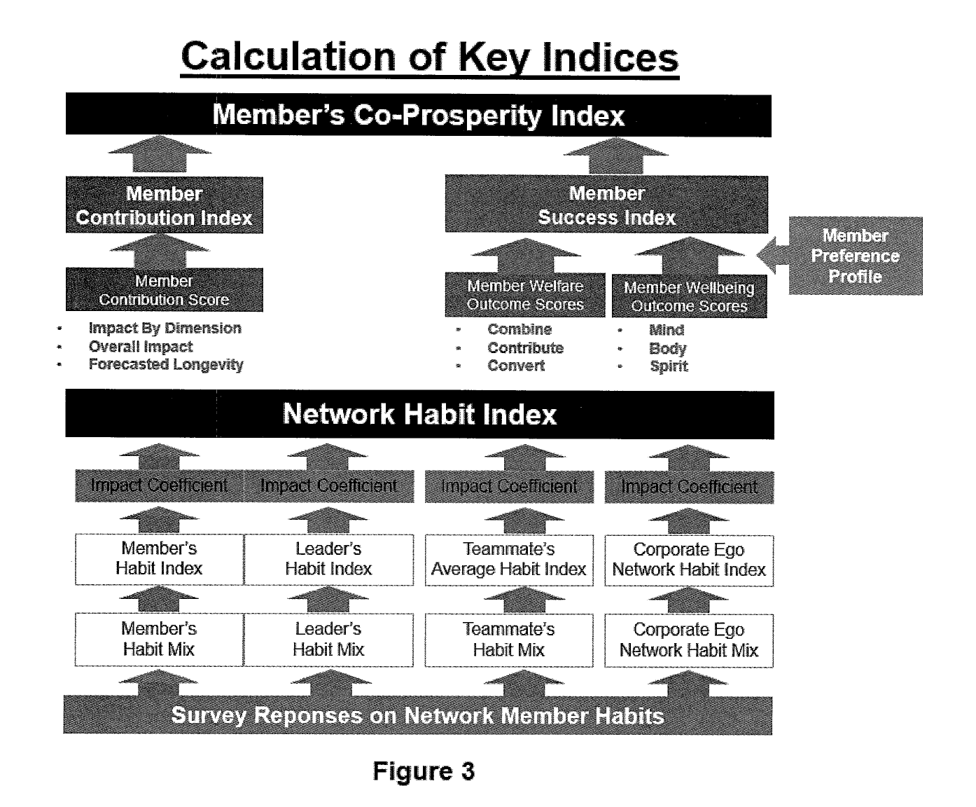

### DETAILED DESCRIPTION OF EMBODIMENTS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

As used herein, an “ego network” is the immediate and direct network of a single individual comprising all of their direct ties. A “subnetwork” is smaller component group within an ego network. Affiliated ego networks either share a group member, or are part of a larger network, such as in a larger organization, such as a business corporation. The network of a large corporation may be made up of hundreds or thousands of affiliated ego networks. A network leader is an individual in any network who occupies a leadership role in the network or subnetwork.

The following description relates to a large business organization, with many subnetworks and ego networks. It is not intended, however, for this invention to be limited to large business organzations. The principles, methods and systems described herein by be adapted by those skilled in the art to apply to any network or organization.

In some embodiments, the methods and systems described herein comprises or implements the steps of compiling a database of key attributes of the members of an ego network; calculating summary indices regarding habits and success for each network member; calculating attribute indices for the overall network; determining the correlation between the habit indices and the success indices to establish equations of the causal relationships between these indices; developing an optimal plan to improve success outcomes of the network; Augmented Intelligence assisted delivery of habit improvement program and tracking of the co-prosperity impact effectiveness of the selected habit change program.

The methods and expert system described herein can overcome the barriers to ego network prosperity improvement that have impeded the effectiveness of existing alternative solutions. This can be done by combining a novel methodology with the novel application of enabling technologies. The following is a summary of these prior art barriers (any one of which can impede the entire effectiveness of alternative solutions) and the solutions made possible by the described embodiments.

It has been considered impractical to gather the necessary network sociometric data to provide accurate and useful analysis. Traditional fixed content surveys are often not completed by network members on themselves and peers because they suffer from excessive length problems. The described embodiments may provide a solution to this problem by being able to customize or dynamically vary the survey content and/or length, by constantly computing in real-time the relative importance of each question answer in order and eliminating any non-critical diagnostic questions.

Traditional approaches cannot provide understanding of the enormously varying causal drivers of the complex relationship dynamics within even small networks. The described embodiments may develop far more sophisticated diagnoses by using a sophisticated core framework for understanding network dynamics and developing empirically validated causal models by applying advanced statistical modelling and scenario modeling.

Network members often lose interest in habit improvement because they fail to see rapid benefits from following the generic advice provided by non-data-based, simplistic habit improvement systems or human coaches. The described embodiments can sustain member engagement by providing higher impact advice by identifying the optimal habit changes and analyzing a database of the relative in-market effectiveness of alternative available habit improvement programs to identify the training program intervention that is most likely to have the greatest impact on the diagnosed improvement opportunity (above).

Concerns about confidentiality and cost issues also deter member participation in traditional habit improvement programs. Many individuals (especially employees) do not want others in their network to be aware of their development efforts. To make matters more challenging, changing ingrained personal relationship habits requires repeated iterated learning cycles. So the required 1:1 coaching from a confidential human coach over an extended period of time that is required to make significant changes to a person's ingrained relationship habits is unaffordable for virtually everyone. The described embodiments can overcome this improvement constraint by using software robots which can provide an unlimited amount of repetitive assistance over whatever period of time that is required for the person to learn the new habits.

Conventional approaches do not provide the ability to understand and continuously improve the entire ego network dynamic. An individual's ego network is usually comprised of many sub-networks, each of which evolves over time due to changing circumstances and resulting group dynamics. Without “always-on” monitoring, no individual or coach would feasibly be able to monitor and adapt their advice and support in the manner needed to create sustained ongoing continuous improvement in the network co-prosperity outcomes. The described embodiments can be designed to trigger the software robot to periodically request the self and peer survey updates needed to constantly monitor the ego network performance. This refreshed sociometric data can also be used to ensure the ongoing robot-delivered program interventions are always effective in generating continuously improving ego network co-prosperity outcomes.

In one embodiment, an expert computer system can be provided for analyzing, improving and monitoring the co-prosperity of ego networks. The analysis step can comprise the step of compiling a database of key attributes of at least one, and preferably each of the members of an ego network. An inventory of relationship habits can be selected which can be used for habit classification. In some embodiments these relationship habits can include some or all of the habits indicated in Table 1.

TABLE 1

| | |
|---|---|
| 1. | Overall Team Working Mindset |
| 2. | Team Working Focus |
| 3. | Commitment To Building A High Performing Team |
| 4. | Desired Benefits From Team Working |
| 5. | Contribution To Combined Effectiveness |
| 6. | Support For Constructive Team Working Rules And Norms |
| 7. | Creating A Psychologically Safe Team Working Culture |
| 8. | Support For Team Solidarity In Adversity |
| 9. | Ensuring Fair Treatment Of All Team Members |
| 10. | Way Of Contributing To The Group Dynamic |
| 11. | Resilience |
| 12. | Self Determination |
| 13. | Optimism |
| 14. | Approach To Superior Personal Achievement |
| 15. | Type Of Achievement Goals |
| 16. | Sharing In The Team's Collective Success |
| 17. | Achievement Style |
| 18. | Team “Game Plan” and Role Definition |
| 19. | Valuing Team Member Opinions |
| 20. | Balance Of Participation In Discussions |
| 21. | Decision-Making Methods |
| 22. | Approach To Handling Challenging Responsibilities |
| 23. | Achievement Focus And Task Prioritization |
| 24. | Risk Taking |
| 25. | Accountability For Completing Team Work |
| 26. | Conflict Resolution |
| 27. | Objective Of Own Personal Growth And Skill Development |
| 28. | Investment In Growing Gifts Into Valuable Specialized Abilities |
| 29. | Regard For Others' Gifts And Potential Contributions |
| 30. | Assigning Responsibilities To Make Use Team Skills |
| 31. | Beneficiary Of The Use Of Special Talents |
| 32. | Degree of Commitment To Assigned Role & Tasks |
| 33. | Engagement In Work Tasks |
| 34. | Consideration Of Alternative Ideas |
| 35. | Response To Stress |
| 36. | Original Thinking |
| 37. | Personal Growth Attitude & Goals |
| 38. | Origin And Level Of Interest In The Teams' Work |
| 39. | Reputation With Co-Workers |
| 40. | Motivation To Give Or Get Help |
| 41. | Approach To Giving/Receiving Help |
| 42. | Type Of Help Given |
| 43. | Approach To Teammate Relationships |
| 44. | Support Of Teammates |
| 45. | Level Of Help Given To Co-Workers (Versus Received) |
| 46. | Outcome Of Exchanging Help With Teammates |
| 47. | Optimism About Teammates |
| 48. | Willingness To Be Helpful First |
| 49. | Knows The Needs Of Others |
| 50. | Development Of Others |
| 51. | Meaning/Helpfulness Of The Teams' Work To Other Stakeholders |
| 52. | Appreciation Of Co-Working |
| 53. | Concern For Optimizing Team Dynamics to Maximize Results |
| 54. | Affiliation with Co-Workers |
| 55. | Dependability To Perform When Helping Others |
| 56. | Proactive Team Builder |
| 57. | Trusting Of Others |
| 58. | Trusted By Others |
| 59. | Consequence For Being Unhelpful |
| 60. | Willingness To Forgive |
| 61. | Peacemaking |
| 62. | Mode Of Self Expression |
| 63. | Interpersonal Sensitivity And Tactfulness |
| 64. | Use of “Social Intelligence” |
| 65. | Response to Conflict Over Differing Opinions |

The habits identified in Table 1 have been empirically validated as necessary and sufficient habits which have a correlation with the prosperity outcomes enjoyed by the members of these networks. The initial formulation of the habit inventory was based on a priori logic and research of subject matter experts but the inventory was subsequently refined and validated through both empirical analysis and via game theory simulation. However, this listing of habits is not exhaustive, and conversely, not all are required in all cases for effective network assessment and outcome prediction. In one embodiment, a subset core set of habits may be identified and used.

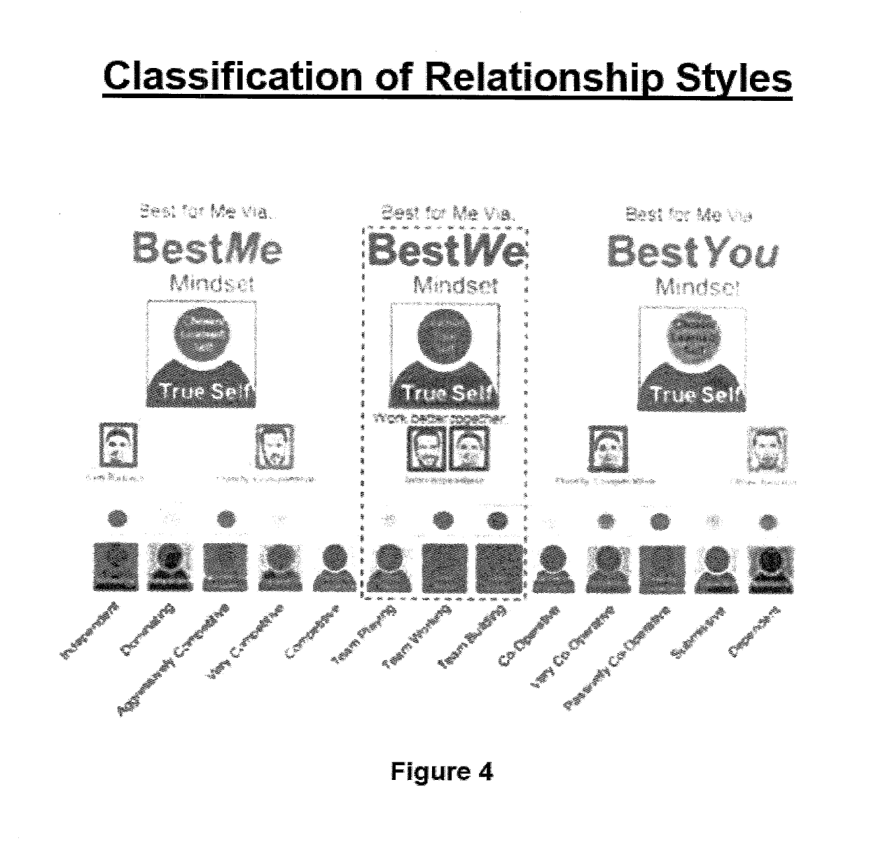

FIG. 4 shows an overview of the classification schema of the basic types of group-working styles of network members. The specific relationship habits of the network member on each of the habit categories selected (preferably all 65 listed above) will vary depending on the overall style adopted by the network member.

The database of key attributes of the network members can be compiled by selecting a specific subnetwork within a member's ego network. A network member can be invited to provide data concerning individual or multiple members by completing a set of peer survey questions concerning the selected relationship habits of the member(s) and the member's impact on the performance outcomes of the network. In some embodiments, each member can be requested to identify more than two other network members with whom they interact most frequently to complete survey on the network members selected relationship habits. This enables the averaging of multiple responses in order to get a more accurate habit profile for the member. Requesting multiple survey inputs also permits greater anonymity for the responses of survey respondents since only combined and averaged peer assessment feedback is subsequently made available to the member.

In a preferred embodiment, each member is assessed for each of the selected habits, with at least two, and preferably three or more descriptors of the member habit. For example, Table 2 below provides an overview of the 65 habit assessment categories along with the range of five general descriptors that can be used to classify the member habits. These answer ranges can form the alternative habit selections for each of the 65 habit categories contained in the peer habit survey. The system can be able to construct a profile of the predominant relationship style of the member by asking the peers to make a selection from the list of habit options on each row.

TABLE 2

| | Team Working | Independent | Competitive | Interdependent | Co-Operative | Dependent |
|---|---|---|---|---|---|---|
| | HABIT Categories | MINDSET | MINDSET | MINDSET | MINDSET | MINDSET |
| Associate | Self determination | Threatened | At Cause | Self assured | At Effect | Victimized |
| | Support for | Autonomous | Non Compliant | Responsible | Compliant | Unquestioning |
| | constructive group- | | | | | |
| | working rules/ | | | | | |
| | norms | | | | | |
| | A psychologically | Overpowering | Oblivious | Advocating | Mindful | Fearful |
| | safe group-working | | | | | |
| | culture | | | | | |
| | Ensuring fair | Uncaring | Self-Serving | Just | Conflicted | Acquiescing |
| | treatment of all | | | | | |
| | group members | | | | | |
| | TEAM WORKING | Dominating | Winning | Synergizing | Supporting | Submitting |
| | FOCUS | | | | | |
| | Desired benefits | Tangible | Tangible | Prosperity + | Intangible | Tangible |
| | from groupworking | Wellbeing Max | Wellbeing | wellbeing for | Wellbeing Focus | Wellbeing |
| | | | Focused | all | | Preserve |
| | Contribution to | Detractor | Uncooperative | Constructive | Uncompetitive | Free Rider |
| | combined | | | | | |
| | effectiveness | | | | | |
| | Way of contributing | Disagreeable | Contentious | Harmonizing | Compatible | Agreeable |
| | to the group | | | | | |
| | dynamic | | | | | |
| | COMMITMENT | Opposed | Questioning | Resolution | Uncommitted | Accepting |
| | TO BUILDING A | | | | | |
| | HIGH | | | | | |
| | PERFORMING | | | | | |
| | TEAM | | | | | |
| | Support for group | Individualistic | Opportunistic | Steadfast | Supportive | Wavering |
| | solidarity in | | | | | |
| | adversity | | | | | |
| | Optimism | Overconfident | Positive | Hopeful | Negative | Hopeless |
| | Resilience | Insecurely | Defensively | Fearlessly | Defensively | Insecurely |
| | | Driven | Strong-Minded | resilient | Weak-Minded | Defeatist |
| Accomplish | APPROACH TO | Gain & Use | Improve Own | Combined | Improve Other's | Avoidance of |
| Synergy | SUPERIOR | Greater Power | Effectiveness | Effectiveness | Effectiveness | Responsibility |
| | PERSONAL | | | | | |
| | ACHIEVEMENT | | | | | |
| | Accountability for | Overbearing | Demanding | Conscientious | Avoidant | Unaccountable |
| | completing group | | | | | |
| | work | | | | | |
| | Team “game plan” | Claim | Claim Desired | Clear roles for | Accept Support | Accept No Role |
| | and role definition | Dominant Role | Role | all | Role | |
| | Valuing group | Only Values | Undervalues | Values all | Overvalues | Only Values |
| | members opinions | Own | Other's | opinions | Other's | Other's |
| | Way of handling | Driven | Determined | Self confident | Unaggressive | Unconfident |
| | challenging | | | | | |
| | responsibilities | | | | | |
| | TYPE OF | Own Outcome | Own | Synergy Goals | Co-Worker | No/Easy Goals |
| | ACHIEVEMENT | Goals | Performance | | Performance | |
| | GOALS | | Goals | | Goals | |
| | Achievement focus | Self-Focused | Task-Focused | Goal-focused | Cohesion- | Other-Focused |
| | and tax | | | | Focused | |
| | prioritization | | | | | |
| | Risk taking | Reckless | Daring | Brave | Conservative | Timid |
| | Achievement style | Authoritarian | Aggressive | Assertive | Passive | Ingratiating |
| | SHARING IN THE | Sacrificing | Winning | Co-Prospering | Losing | Sacrificing Self |
| | TEAM'S | Others | | | | |
| | COLLECTIVE | | | | | |
| | SUCCESS | | | | | |
| | Balance of | Overpowering | Greater Talk | Balances | Lesser Talk Time | Deferential |
| | participation in | | Time | contributions | | |
| | discussions | | | | | |
| | Decision-making | Unilateral | Win The Debate | Best group | Majority Rule | Avoid The |
| | methods | Decision | | decisions | | Decision |
| | Conflict resolution | Autocratic | Active | Proactive | Reactive | Inactive |
| Actualize | OBJ. OF | Supported | Superior | Valuable | Supportive | Subordinate |
| | PERSONAL | Contributor | Contributor | Contributor | Contributor | Contributor |
| | GROWTH AND | | | | | |
| | SKILL | | | | | |
| | DEVELOPMENT | | | | | |
| | Response to stress | Failure | Task Security | Self respecting | Relationship | Acceptance |
| | | Insecurity | | | Security | Insecurity |
| | Beneficiary of the | Mainly Self | Self Benefit | Mutual benefit | Others Benefit | Mainly Others |
| | use of special | Benefit | More | | More | Benefit |
| | talents | | | | | |
| | Commitment to | Territorial | Rivalrous | Diligent | Accepting | Uncommitted |
| | assigned role & | | | | | |
| | tasks | | | | | |
| | Original thinking | Knowing | Predictable | Creative | Conforming | Unoriginal |
| | INVESTMENT IN | Workaholic | Perfectionistic | Self Actualizing | Conventional | Underinvests |
| | GROWING GIFTS | | | | | |
| | INTO VALUED | | | | | |
| | ABILITIES | | | | | |
| | Origin and level of | Interested in | Interested in | Intrinsically | Interested in | Interested in |
| | interest in the | Self | Tasks | interested | Harmony | Relationships |
| | groups' work | | | | | |
| | Engagement in | Workaholic | Intense | Fully engaged | Somewhat | Disengaged |
| | work tasks | | | | Engaged | |
| | Personal growth | Compulsive | Intent | Continuously | Willing | Complaisant |
| | attitude & goals | | | improve | | |
| | REGARD FOR | Dismissive | Undervalues | Respectful of | Overvalues | Intimidated |
| | OTHERS′ GIFTS & | | | All | | |
| | POSSIBLE | | | | | |
| | CONTRIBUTIONS | | | | | |
| | Assigning | Controlling | Self interested | Utilizes gifts of | Not insistent | Tolerant |
| | responsibilities to | | | all | | |
| | make use of group | | | | | |
| | skills | | | | | |
| | Consideration of | Closed Minded | Biased | Open minded | Unassertive | Not mindful |
| | alternative ideas | | | | | |
| | Reputation with co- | Disreputable | Negative | Respected | Positive | Unrespected |
| | workers | | Reputation | | Reputation | |
| Assist | MOTIVATION TO | Own Benefit | Own | Unselfish Team | Others | Other's |
| | GIVE OR GET | | Performance | Building | Performance | Approval |
| | HELP | | | | | |
| | Appreciation of co- | Very | Unappreciative | Grateful | Relieved | Mixed Feelings |
| | working | Ungrateful | | | | |
| | Approach to | Power Seeking | Competitive | Humanistic | Cooperative | Approval |
| | groupmate | | | | | Seeking |
| | relationships | | | | | |
| | Support of | Unwelcoming | Unwilling | Teaming | Willing | Doormat |
| | groupmates | | | | | |
| | Helpfulness of the | Only | Tasks More | Seeks meaning | Relationships | Only |
| | groups' work to | Prosperity | Important | | more Important | Relationships |
| | other stakeholders | Important | | | | Important |
| | TYPE OF HELP | Little Help | Easy Help | Valuable Help | Requested Help | Any Help |
| | GIVEN | | | | | |
| | Optimism about | Pessimistic | Cautious | Optimistic | Wishful | Naïve |
| | groupmates | | | | | |
| | Knows the needs of | Inconsiderate | Unobservant | Observant | Overly Observant | Hypersensitive |
| | others | | | | | |
| | Development of | No Interest | Unenthusiastic | Enthusiastic | Reserved | Reluctant |
| | others | | | | | |
| | APPROACH TO | Exploitative | Takes Help | Reciprocates | Gives Help | Exploitable |
| | GIVING/ | | | Helpfulness | | |
| | RECEIVING HELP | | | | | |
| | Outcome of | Win At Any | Win-Lose | Win-win | Lose-Win | Lose |
| | exchanging help | Cost | | | | |
| | with groupmates | | | | | |
| | Willingness to be | Nasty | Uncharitable | Nice | Accommodating | Pushover |
| | helpful first | | | | | |
| | Level of help given/ | Unhelpful | Less Helpful | Appropriately | More Helpful | Too Helpful |
| | received with co- | | | helpful | | |
| | workers | | | | | |
| Affiliate | FOCUS ON | Destructive | Self Serving | Responsible | Yielding | Inhibited |
| | OPTIMIZING | | | | | |
| | TEAM | | | | | |
| | DYNAMICS FOR | | | | | |
| | MAX RESULTS | | | | | |
| | Interpersonal | Insensitive | Tactless | Attuned & | Tactful | Hypersensitive |
| | sensitivity and | | | astute | | |
| | tactfulness | | | | | |
| | Proactive “team” | Unconcerned | Inconsistent | Role model | Adheres | Easily |
| | builder | | | | | influenced |
| | Response to | Strong-Willed | Judgmental | Integrative | Pacifying | Agreeable |
| | conflict over | | | | | |
| | differing opinions | | | | | |
| | Consequence for | Revengeful | Tough | Correcting | Permissive | Enabling |
| | being unhelpful | | | | | |
| | AFFILIATION | Resistant | Not affiliative | Genuinely | Overly Affiliative | Reliant |
| | WITH CO- | | | Positive | | |
| | WORKERS | | | | | |
| | Trusting of others | Distrustful | Cautious | Trusting | Indulgent | Susceptible |
| | Mode of self | Closed | Guarded | Open, honest & | Cautious | Uncomfortable |
| | expression | | | direct | | |
| | DEPENDABILITY | Insufficiently | Unreliably | Dependably | Excessively | Inappropriately |
| | TO PERFORM | Cooperative | Cooperative | Cooperative | Cooperative | Cooperative |
| | WHEN HELPING | | | | | |
| | OTHERS | | | | | |
| | Use of “social | Manipulative | Calculating | Diplomatic | Appeasing | Accepted |
| | intelligence” | | | | | |
| | Willingness to | Grudging | Unforgiving | Forgiving | Indulgent | Pushover |
| | forgive | | | | | |
| | Peacemaking | Obstinate | Stubborn | Peacemaking | Conciliatory | Naïve |

In some embodiments, the survey data on the selected habits of network members can be gathered from the other peer network members by providing a survey application whereby the network members can enter their responses to the questions. In some embodiments, the survey application can be network, web based or a mobile app. The survey application can provide a secure, password protected access to the survey questions, which can protect the confidentiality of the responses without risk of disclosure to the network member being assessed.

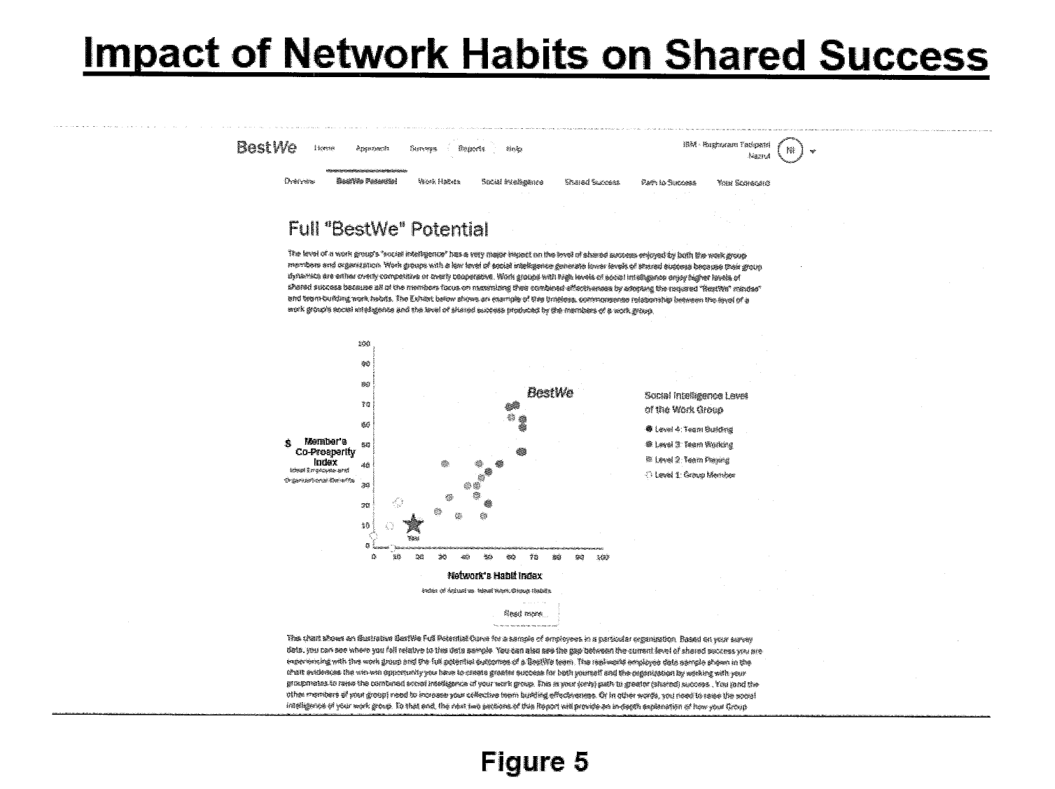

FIG. 5 shows a screenshot of an embodiment of the core report page on the secure member website, which shows the correlation between relationship habits of the network (Network Habit Index) and the member's Co-Prosperity Index (CPI). The X axis shows the Network's Habit Index (NHI). The Y axis shows the member's Co-Prosperity Index (CPI). The scatterplot shows how the success of the member in creating greater success for themselves and contributing to success of others in their group (referred to as their shared success or Co-Prosperity Index) is a function of the degree to which the network they are in adopts productive relationship habits (referred to as the Network Habit Index). The relationship between these two variables causes the individual member-dots on this chart to correlate positively. The yellow star indicates where the user receiving the coaching report is currently is situated relative to other members of the same or similar networks. This data is provided to each network member to help them understand how the data evidences the opportunity for the members of networks to improve their shared success by focusing on adopting the highest level of relationship habits.

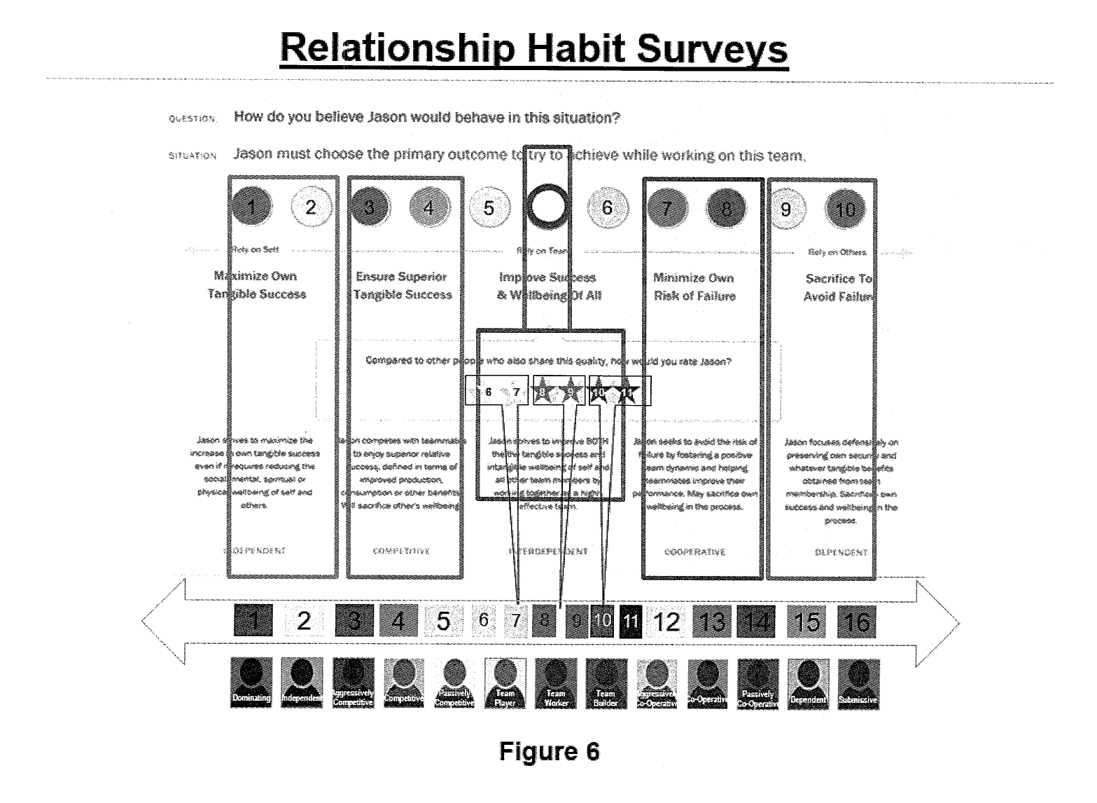

FIG. 6 is an embodiment of an example of one of the habit questions in the automated survey application showing how the habit range selections made by the respondent can be classified according to the classification system of group-working styles shown in FIG. 4 and assigned a numerical value.

The database of key attributes of the network members can include data from self-surveys. Survey questions can be based on selected welfare and wellbeing outcomes (success outcomes) from participating in the network. Each network member can complete a SELF survey regarding their own success outcomes from participating in this network, habits when interacting with the other members in this network, and perceptions of the habits of the network leader (if any), the other network members, and the relationship habit norms of any broader contextual network (such as an organization) if any within which the network resides or is affiliated.

Wellbeing and welfare are both success outcomes, and collectively are used to determine or describe “prosperity”. In some embodiments, the selected success outcomes can be determined by asking the network member to state their degree of agreement with success statements which describe the six ideal group-working welfare (#1-3 below) and wellbeing (#4-6 below) improvements uniquely available to individuals working in interdependent groups with the high level of social intelligence needed to adopt co-prospering relationship habits. In some embodiments these following survey question statements are used to determine the member's experience of their relative level of benefits being experienced in each of these six areas as a result of their current network dynamics:
1. Combine—Combining Synergistically: Everyone is striving to work together synergistically to achieve a much higher level of combined performance and results than we otherwise would have achieved as independent contributors. (1+1=111)
2. Contribute—Contributing Fully: My work within this group allows me to contribute to my full potential towards the success of the group by making the best use of my most unique gifts and valuable skills.
3. Conversion—Sharing Fairly: My relative contribution (versus other group members) to the overall success and results of the group is accurately assessed, fairly recognized and appropriately rewarded.
4. Body—Engaging Healthfully: I am able to contribute fully and healthfully towards the challenging goals of this group because everyone works together so cooperatively it makes me feel secure, energized, and resilient to stress.
5. Mind—Flourishing Mentally: Working in this group adds significantly to my overall level of life satisfaction by providing me with the everyday happiness and other constructive workplace experiences that allow me to flourish mentally.
6. Spirit—Aligning Ethically: I have a great respect for this organization, group leader and group because their ethics and resulting workplace practices align with my own fundamental core values.

In some embodiments, the first three success outcomes (Combination, Contribution, Conversion) may be considered “Welfare” success outcomes, while the latter three (Body, Mind, Spirit) may be considered “Wellbeing” success outcomes.

The peer survey and self-survey response data (on relationship habits and success outcomes) is aggregated into the database summarizing these key attributes of the network members based on the survey responses gathered from all network members. This database is used in the calculation of the Habit Index used to classify relationship style each network member. The self-survey question response can also be used to calculate the Success Index for each member.

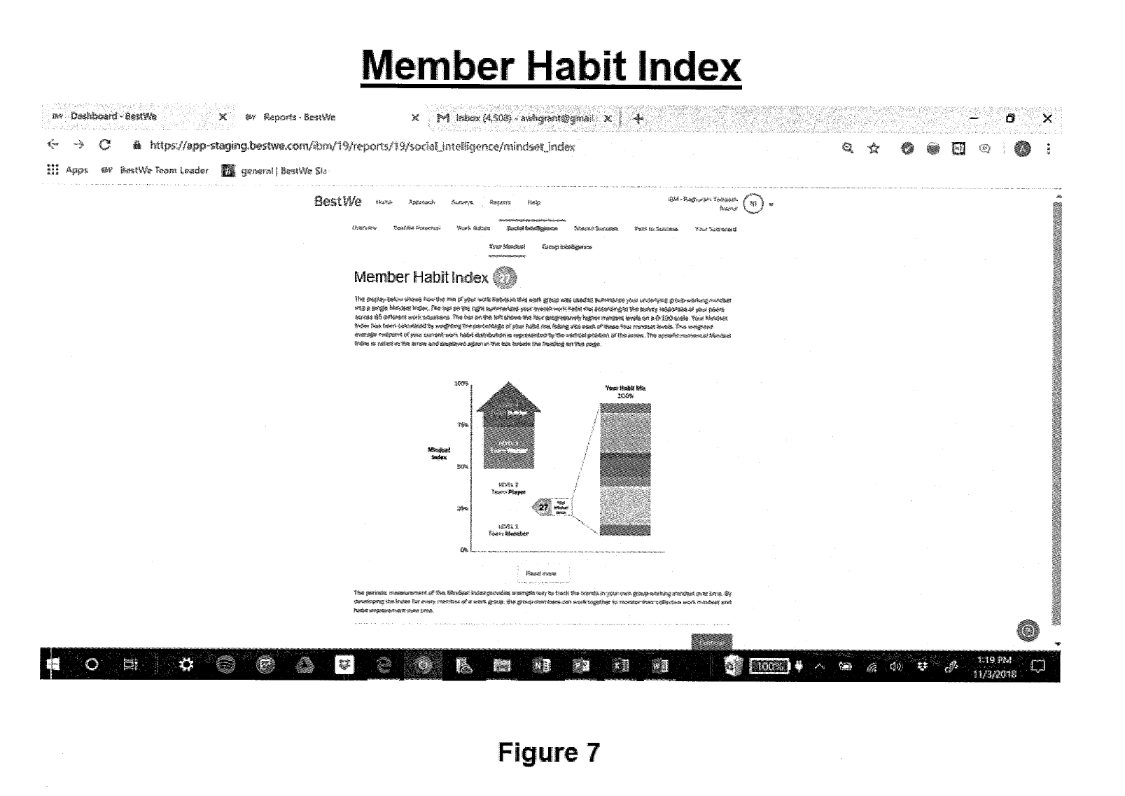

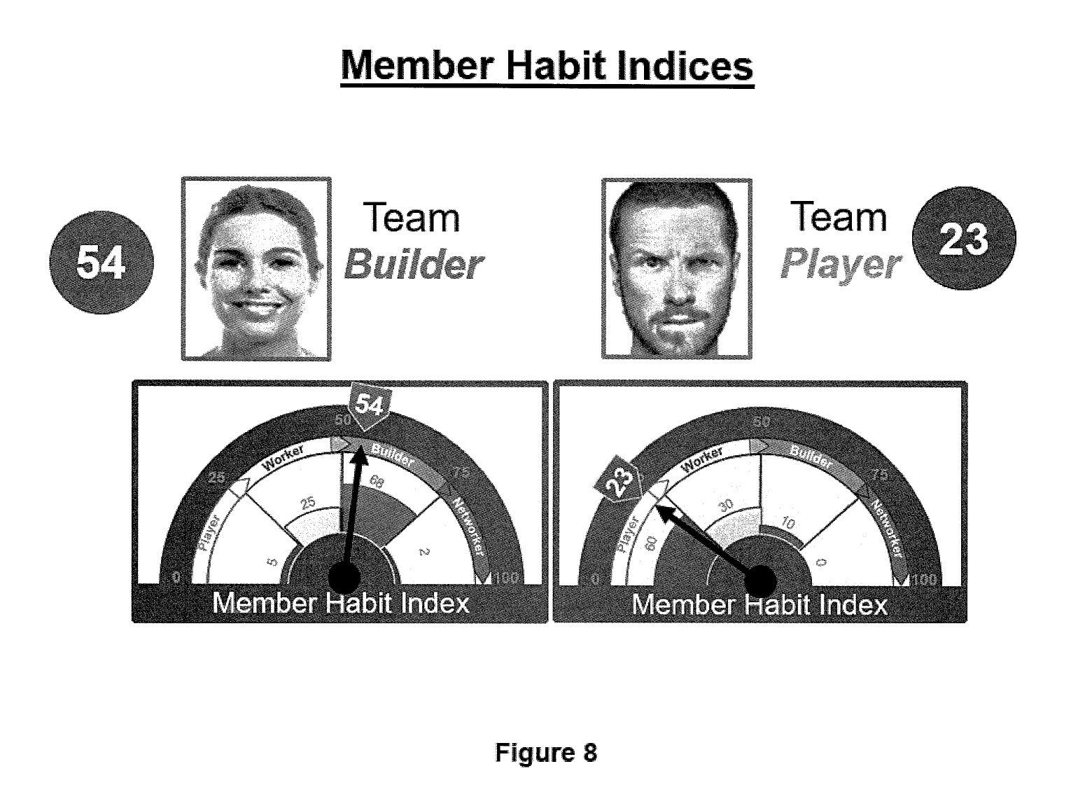

A Member Habit Index can be calculated. The Member Habit Index is a numerical classification of the network member's group-working style. The Member Habit Index can be calculated by classifying each of the responses from each of the peer surveys for the network member to the habit-related questions according the classification system of group-working styles and then aggregating all of the peer answers to the habit-related survey questions in order to compile a frequency distribution of the network member's group-working habits. FIG. 7 shows a sample frequency distribution, where the MHI is calculated by weighting the percentage of the member's habit mix falling into each relationship style category, in this case four levels named Team Player, Team Worker, Team Builder and Networker. The levels are used as simplifying descriptive ranges to classify the general level of the Member Habit Index. The statistical midpoint of this frequency distribution of all of the habit survey question responses is used to calculate the Member Habit Index. FIG. 8 is a visual representation of the Member Habit Indices for two network members.

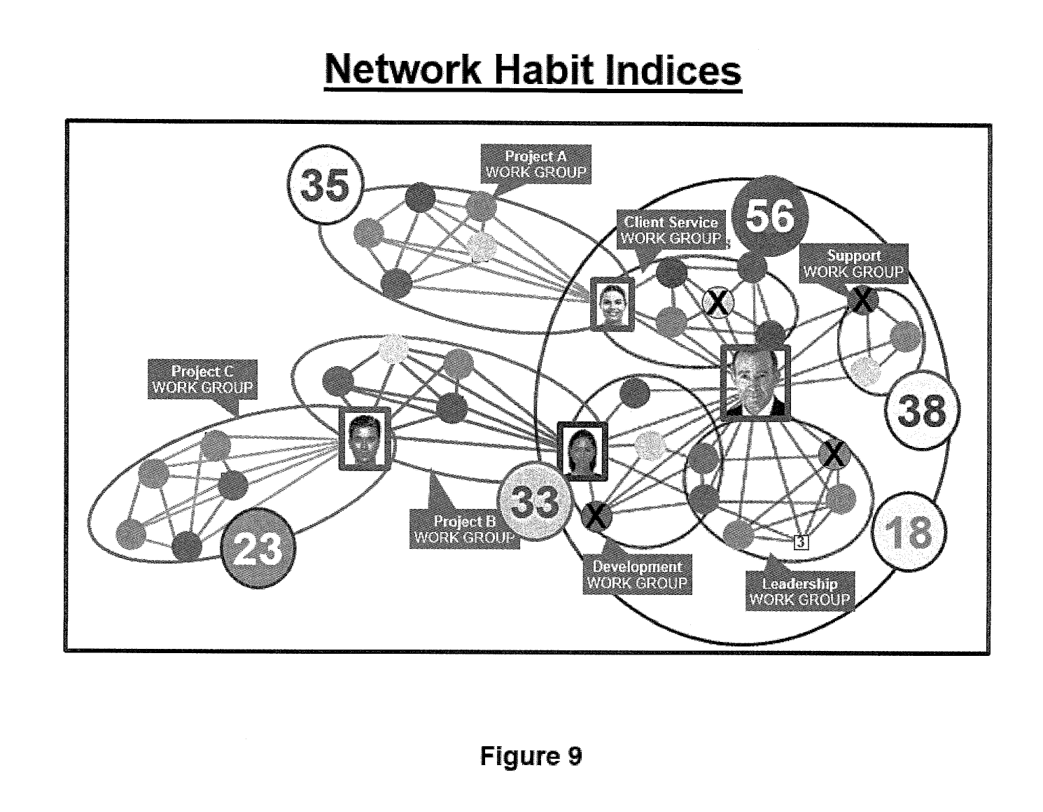

By repeating this process of survey question response analysis, a Member Habit Index number can be calculated for each member of any particular network or sub-network. FIG. 9 shows a mapping of individual Member Habit Indices (which may color coded for convenient graphical display). The MHIs for a selected grouping, which may be a network or sub-network, may be averaged or otherwise aggregated in to a Network Habit Index numbers for members of various subnetworks.

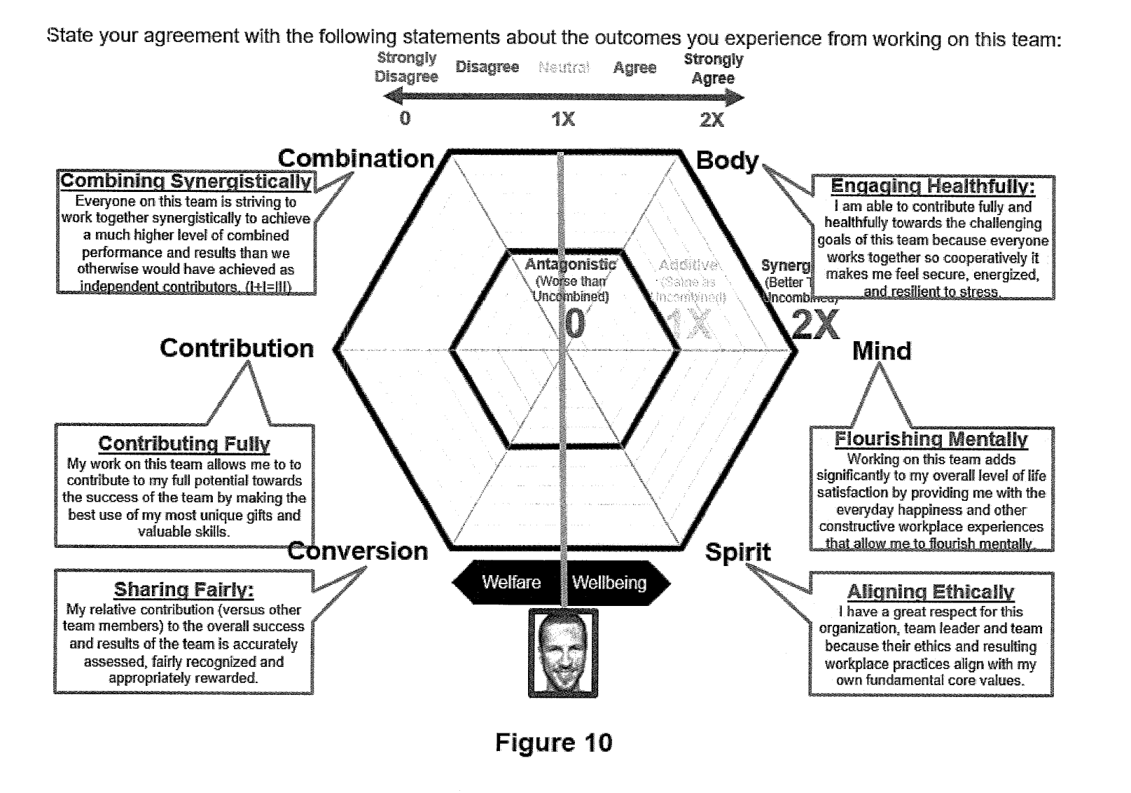

A Member Success Index can be calculated. The Member Success Index can be a numerical representation of the success outcomes experienced by a network member. In some embodiments, the Member Success Index can be calculated as the weighted average of the network members responses to the self-survey questions concerning selected key group-working success outcomes. In some embodiments, the above mentioned six dimensions for measuring the success outcomes can be weighted together to create the Member Success Index representative of the overall success (or alternatively referred to as the prosperity) level of the particular network member. FIG. 10 illustrates the welfare and wellbeing dimensions included in calculating a Member Success Index. In this example, a degree of agreement or disagreement with a particular success statement provides a score in each dimension. Scores on the midpoint of the radius range reflects no added benefit is being experienced from the member's group-working. Scores at the furthest point in the radius range indicate the member is enjoying the maximum personal benefit from their group-working. Scores at the origin of the radius indicate the member is experiencing the maximum possible loss of benefit from their group-working.

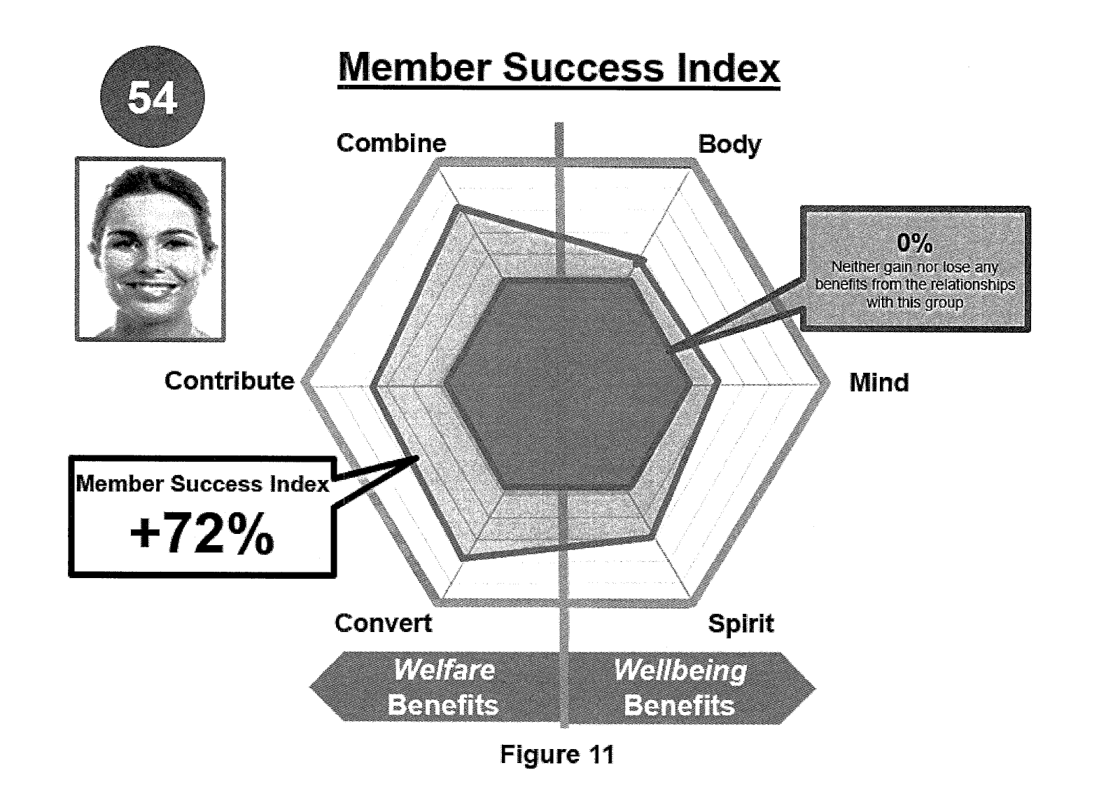

FIG. 11 is an example of the mapping of the actual success outcome scores from a user and how they are used in calculating the Member Success Index. Zero percent is indicative a “Neutral” position on the success statement, while 100% is indicative of “Strongly Agree”. As shown in the figure, the Member Success Index can be calculated by averaging the member's benefit across all of the six factors. In some embodiments the methodology can be refined by allowing the network member to weight their relative interest in each of the success outcomes. This weighting can be used to create a Member Success Index that can be personalized to each network member's preferred outcomes.

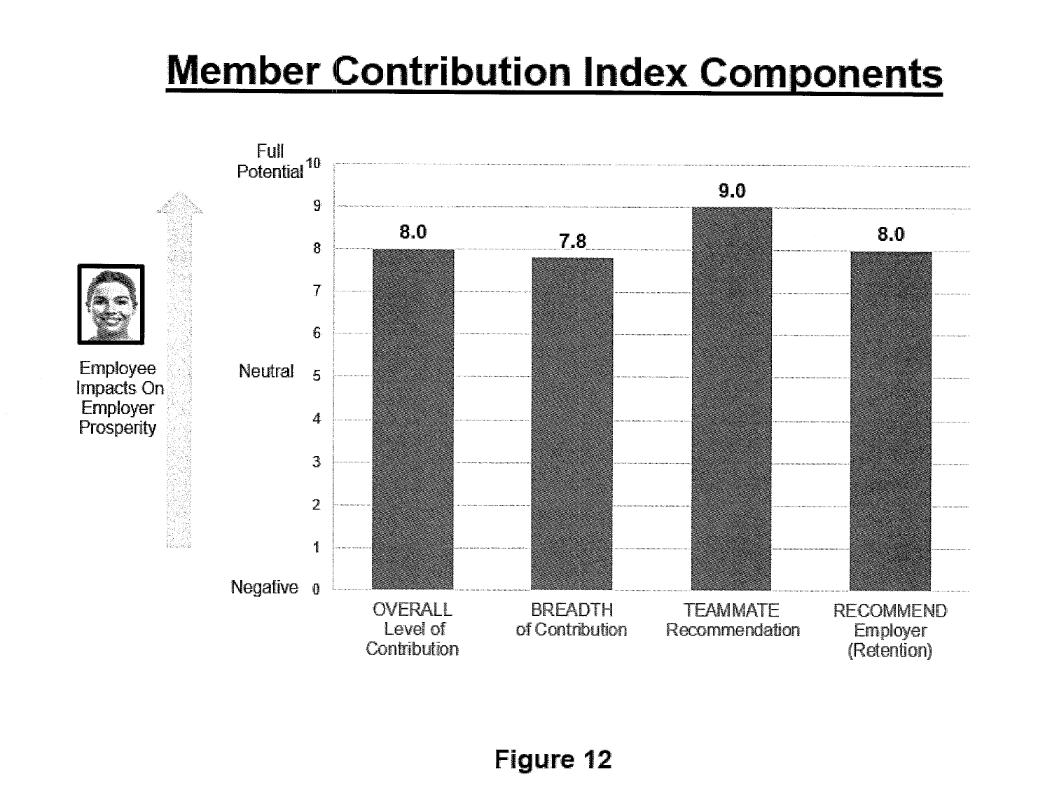

A member Contribution Index can also be calculated. A Member Contribution Index can be calculated by averaging the subjective responses of the members to survey questions concerning the degree of effectiveness of the network member in achieving full potential contributions to the network's performance. The level of the members contributions to the success of the group can be established a variety of ways depending on the data sources available. A basic approach is to get the perceptions of the member's peers by inserting relevant questions into the peer survey. An example of the questions used to capture peer perceptions of the impact of the network member on the network's prosperity outcomes is shown in FIG. 12. In the example shown the members contribution to the network was defined as being a function of four factors: the overall impact of the member, their style of results achievement, their breadth of impact and their likelihood to stay with their employer (estimated based on the members willingness to recommend the employer). These survey based values can be averaged in the determination of the initial Member Contribution Index.

In some embodiments, an organization with an interest in the performance outcomes of it's networks (such as an employer) can subsequently provide data on a members contribution to a (work) group through more direct contribution metrics. In these cases this more objective data can be used in compiling the Member Contribution Index. This additional data can be the actual member productivity statistics or performance ratings that are captured by the employer on each employee. Since these statistics may provide a more direct and/or objective representation of the relative contribution of the member, these statistics can be added into the calculation of the Member Contribution Index when they are made available. The relative weighting of these statistics relative to the more subjective survey-result derived Index may be varied.

A summary metric representing the member's impact on their own prosperity and the prosperity of the overall group can also be determined. This is referred to as the member's Co-Prosperity Index.

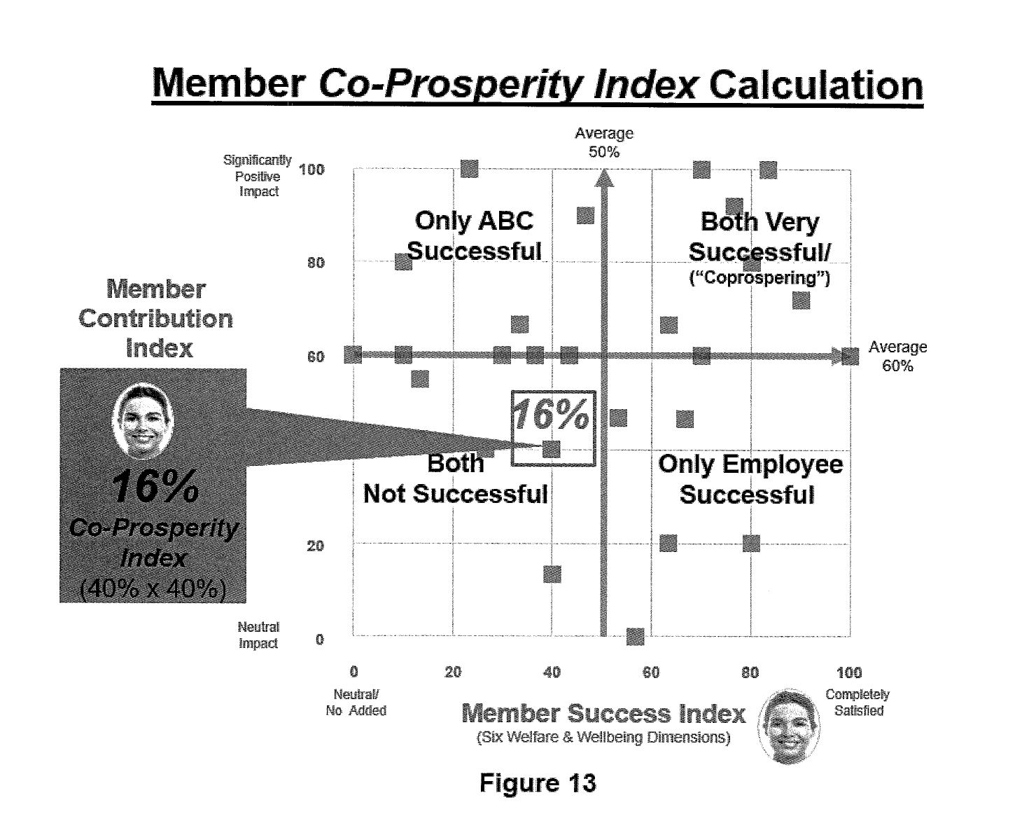

Each member's Co-Prosperity Index can be calculated. This Co-Prosperity Index is indicative of the level of success of the member, measured both in terms of the benefits they enjoy themselves from working in the network, but also in terms of the level of their contribution to the network's success. The Index incorporates both the level of group-working benefit enjoyed by the member by using the Member Success Index, and the level of contribution made by the member to the network's overall success using the Member's Contribution Index). In some embodiments, the member's Co-Prosperity Index can be calculated by multiplying the Member Success Index of a network member by the Member Contribution Index. FIG. 13 shows a graphical representation of this member Co-Prosperity Index calculation. In the example shown, the Member Success Index of 40% is multiplied by the Member Contribution Index of 40% to give the member Co-Prosperity Index of 16. It provides a convenient summary of the degree to which the member is achieving 100% of the ideal success potential for both themselves and the other members of the group. In this example the member is achieving only 16% of this potential.

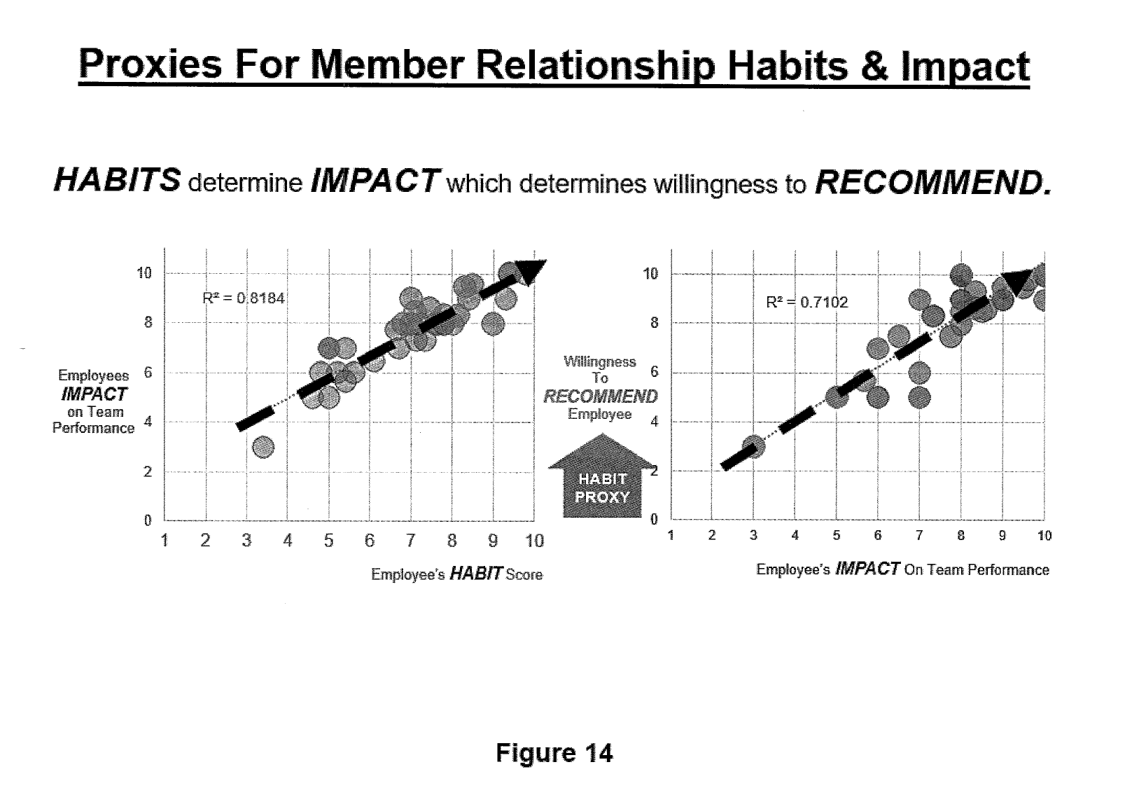

A Network Habit Index can be calculated. The Network Habit Index can be calculated for any network. to represents the degree to which all of the network members are employing the highest performing (interdependent) work habits. The Network Habit Index is calculated by weighting the Habit Indices of the network members. Since various network members (such as a group leaders) can have differential impacts on the network success outcomes, the combined Network Habit Index calculation needs to provide for differential weightings of the individual group member habits. With larger data samples these relative weightings can be derived statistically. In small sized networks situations the system will initially apply an equally weighted averaging of the the Habit Indices of the network member, the peers of the network member, the network leader (if any), and any broader contextual network (such as an organization) if any within which the network resides or is affiliated. Using these four factors, in some embodiments, a Network Habit Index can be calculated by averaging the Member Habit Index of the network member, the Member Habit Index of the network leader, and the average of the Member Habit Indices of the member's peers in the network. Optionally, the Network Habit Index can be further weighted to reflect the impact of organizational habits external to the network but which stills impacts the network. For example, the average of Member Habit Indices of other members of the broader organization surrounding a specific work group may be introduced into the equation. This is illustrated in FIG. 14. The different components which result in

In some embodiments, the system may not have a complete data set on the relationship habits of all peers in a network, so proxy variables can be initially substituted for this missing data. These proxy variables can be based on questions asked in the self survey regarding the network member's willingness to recommend his or her network colleagues, group leader (if any) and the broader contextual network (such as an organization), if any, within which the network resides or is affiliated to a friend or associate. FIG. 14 shows a graph representing how a peer's assessment of a network member's impact on the network outcomes can be correlated to both their assessment of the member's habits and their willingness to refer them to a friend or associate. Therefore, the answer to the question regarding the member's willingness to refer the peer network member to a friend or associate can be a good proxy for the actual peer habit assessment survey responses. So these proxy answers can be substituted in calculating the Network Habit Index in cases where actual habit data is not available. The proxy answers may be replaced with actual habit data when it becomes available.

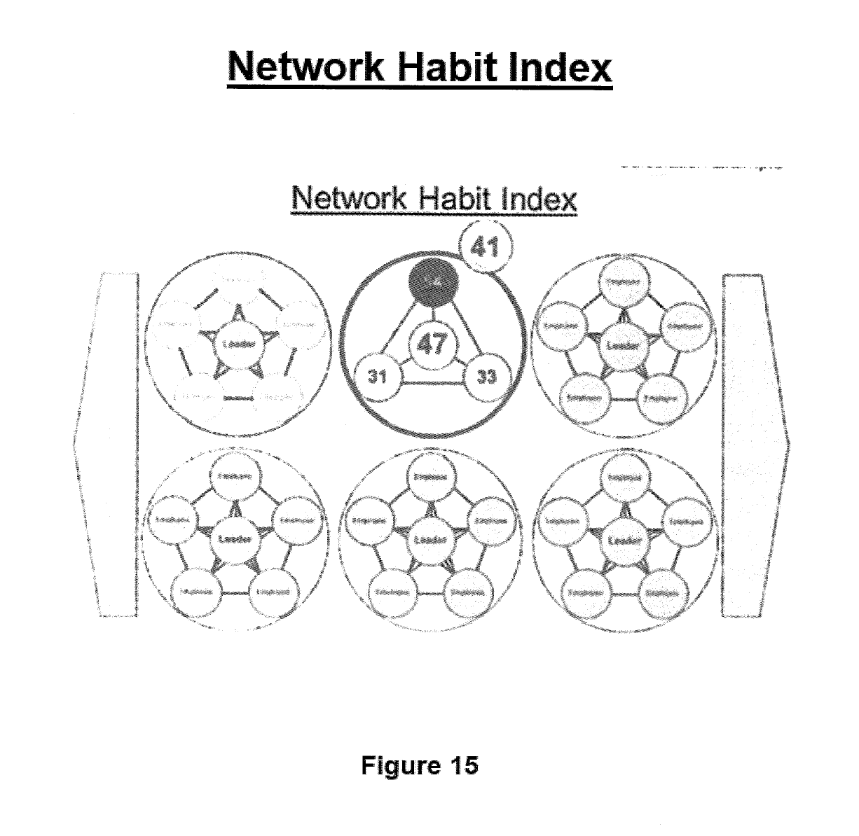

FIG. 15 shows a representation of the Network Habit Index calculation. In this illustration, (assuming an equal averaging of the Member Habit Indices of the members and the other individuals in the work group network), then the Network Habit Index of 41 would be calculated as follows:

41=(54+47+31+33+30)/5

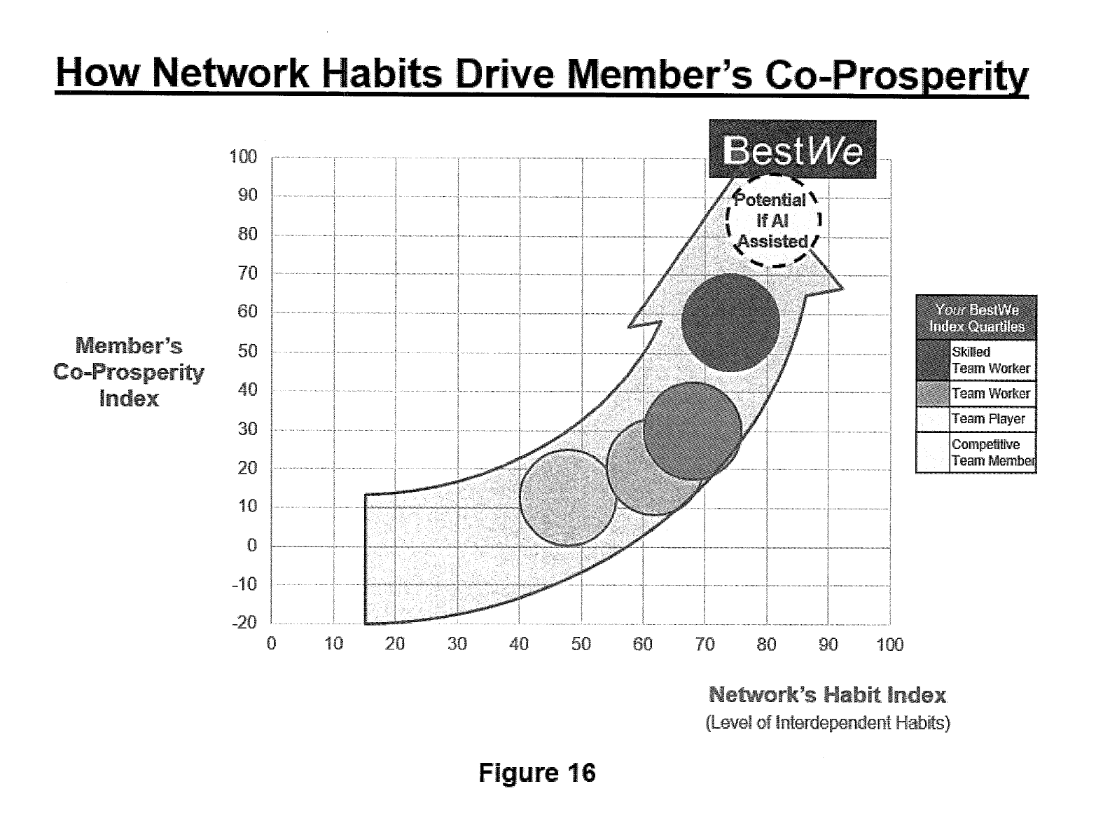

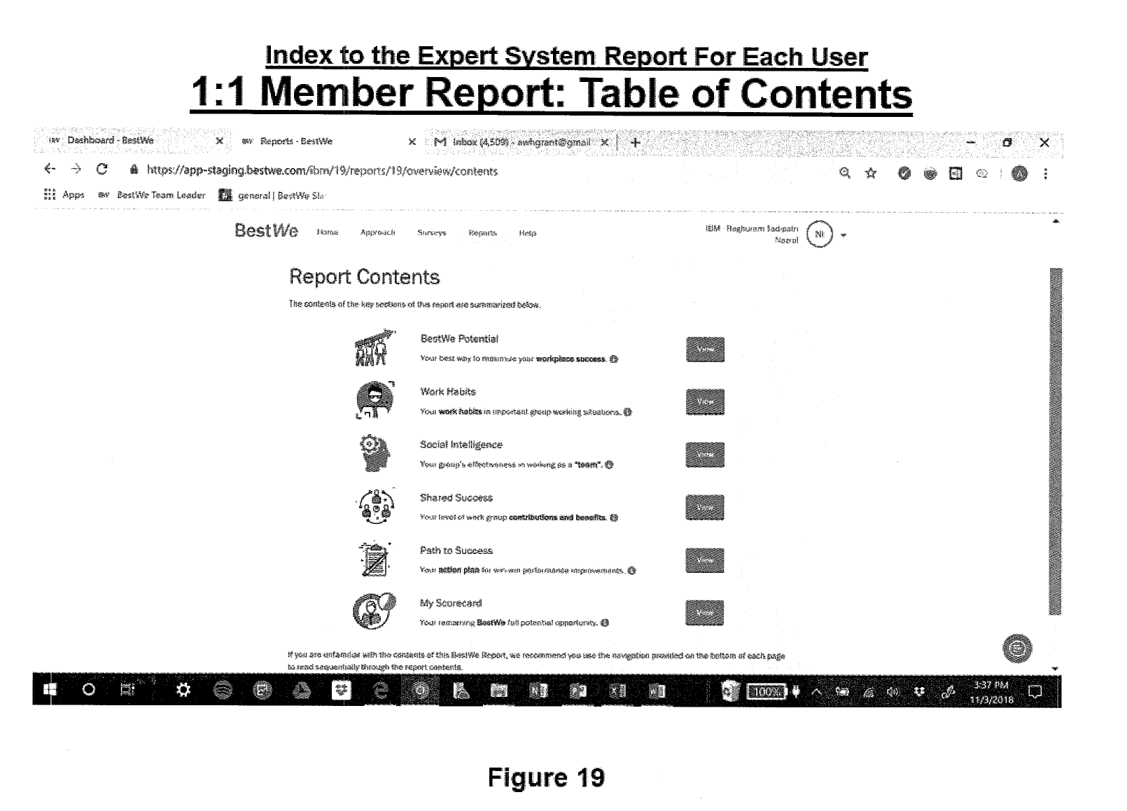

Embodiments of a system are configured to determine the correlation between the group's Network Habit Index and the resulting member's Co-Prosperity Index, in order to discern the equations describing their causal relationship. This results of this analysis is visually illustrated in FIG. 5. FIG. 16 shows another sample correlation between the Network Habit Index of the whole group and the Co-Prosperity Index for the members of a sample network. In this example the member-level data has simply been aggregated into four quartiles. However as shown in the process flow depicted in FIG. 19, the system can also apply a correlation analysis at a lower level to determine the relative impacts of the habits of the various members of the group used in calculation of the Network Habit Index described above: network member, network peers, network leader if any and the broader contextual network (such as an organization) if any within which the network resides or is affiliated. This analysis can be used to understand the impact of these various parties on the Member Success Index. By establishing the equations of the causal relationships with the greatest relative fit Impact Coefficients can be identified for each party. These coefficients can be used to determine the most effective ways for the network member can achieve a defined increase in their Member Success Index. (For example, if the team leader is discovered to have a disproportionately impact on the member's Success Index the member's expert advice would be focused on tactical ways to elevate the habits of the group leader.)

These Impact Coefficients can have predictive utility when calculating the likely impacts of the various improvements in the habits of network members (the network member, network peers, network leaders or the broader contextual network (such as an organization) if any within which the network resides or is affiliated) on the success outcomes of the member and the network overall. For example, the easiest path to improved success for the network member might be shown to require working with their groupmates to improve their habits in a specific situation where their groupmates collective Member Habit Index was low and the Impact Coefficients showed that a small improvement in groupmate habits would create a large increase in the network member's Member Success Index. Alternatively, if the group leader's Member Habit Index was already high and the coefficient showed that further large increases would be needed just to generate a small increase in the network members Member Success Index, then working to improve the group leader's habits would not be a feasible path to greater success for the network member. In each instance, the correlation analysis may comprise methods of multivariable regression analysis, such as those described in Applied Multivariate Data Analysis, Second Edition (Brian S. Everitt, Graham Dunn) Print ISBN:9780470711170|Online ISBN:9781118887486|DOI:10.1002/9781118887486 (the entire contents of which incorporated herein by reference).

This modeling can also be applied at an even lower level to understand the Impact Coefficients of the various relationship habits (within the overall Habit Index) on the Success Index outcomes of the ego-member. For example, a member who was exhibiting overly competitive relationship habits and had a low Member Habit Index might want to know the single best habit to change to have the greatest improvement in their Member Success Index. For example, an examination of the Impact Coefficients between each habit and the Member Success Index might be used to determine that the single habit of “exhibiting increased job-related helpfulness” would be the single highest-impact habit change to focus on.

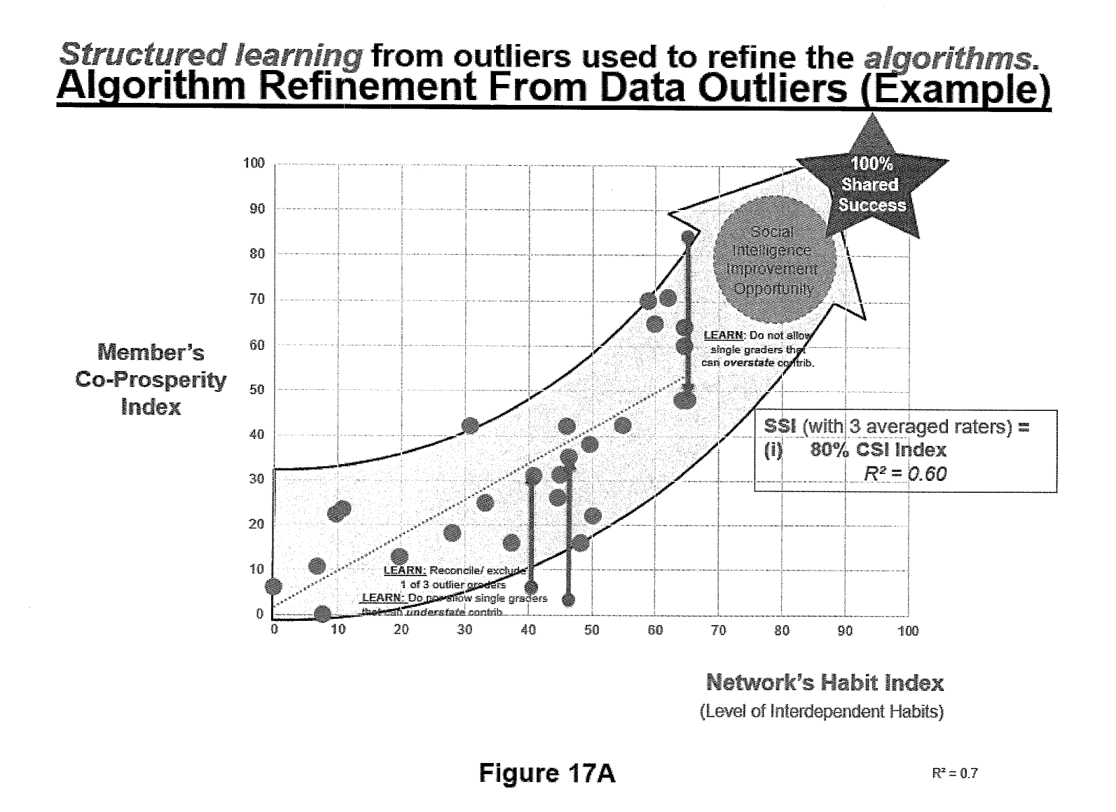

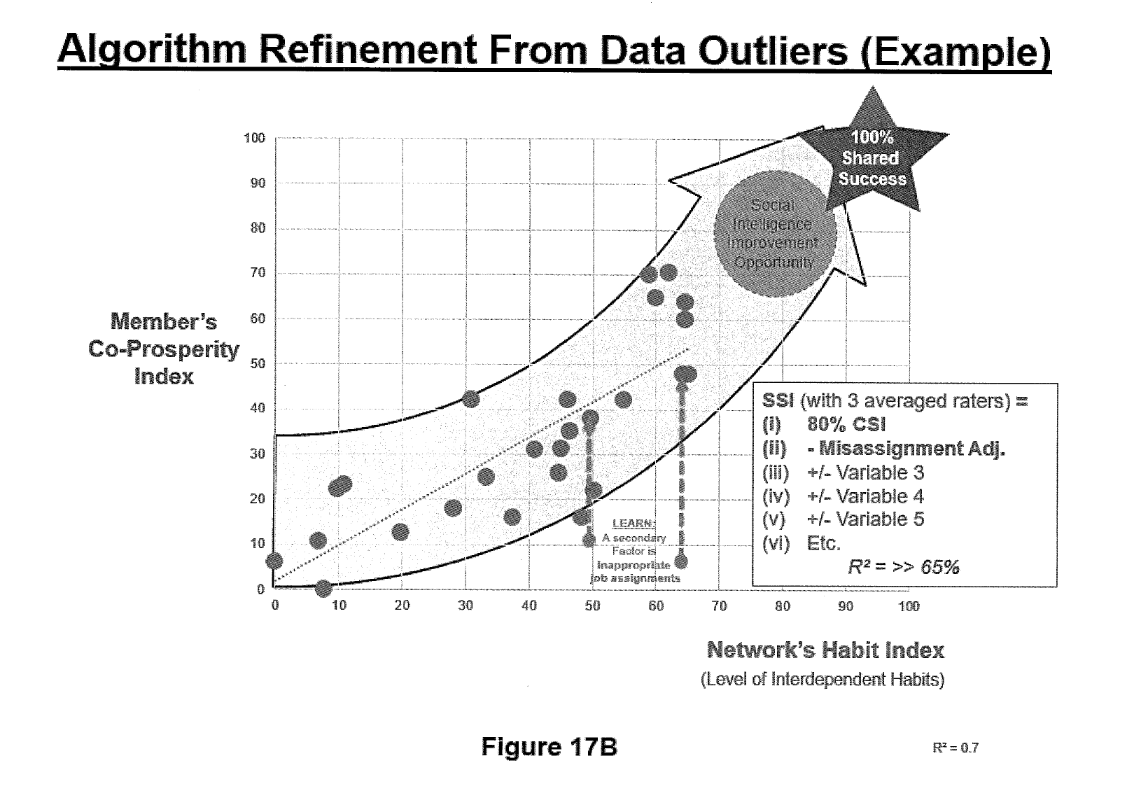

The system may also gain increasingly deeper levels of expert intelligence as machine learning can be used to enhance the diagnostic performance of the system as the database of survey data sets increase in number and size. For example, the system will progressively improve the performance of the predictive algorithms by using machine learning capabilities to identify new insights in the increasing number of data sets. For example, FIG. 17a shows an expected base relationship between the the Co-Prosperity Indices of various network members and their Network Habit Index. As expected, individuals in networks with a higher Network Habit Index enjoy higher levels of o-prospering. This core correlation provides the base way for an expert system to provide advice. The system can define the way(s) to increase the member's Co-Prosperity Index simply by identifying the specific network habit changes required to increase the Network's Habit Index. However, there frequently will exist outliers, as shown in the Figure, that are not fully explained by this simple single variable relationship between the member's Co-Prosperity Index and the Network Habit Index.

FIG. 17a shows an example of these outliers to the expected correlation. The expert system examines these outliers to look for and define the other variables which may explain this additional variation, and then incorporates them in the updated algorithms.

FIG. 17b, similarly to FIG. 17a, shows how the majority of member data points fall where expected. The figure shows the investigation of the drivers on these outliers in the next data set may be due to very different causal variables. This persistent analysis of outliers is used to drive the ongoing structured learning which continually enhances the advisory intelligence of the platform. Defining these various underlying causal variables provides enormous proprietary diagnostic power for the expert system to use when determining the degree of network habit change that is required to help each network members achieve greater levels of success.

The expert system can examine the data sourced from the group member surveys to enable the identification of substantially shortened surveys. As the system becomes more intelligent about the most important drivers of group success outcomes, it can ask a much more focused series of minimized survey questions. For example, as a starting set of most predictive survey questions are progressively answered, the system can know in real-time if the answers were sufficient to perform a reliable diagnosis. In these cases the survey process can be ended. In the event that a particular case still appeared like an “outlier” the system could continue to ask additional necessary and sufficient questions to be able to diagnose the underlying causal relationships. If the system is unable to fully discern the underlying causality, it may request additional data by posing even more survey questions, or to resolve unexplained survey response variability by including additional survey peers.

The listing in Table 3 includes some main categories of data which is predictive of network performance and that can be asked (progressively) as part of the member's self-survey process. This listing is not intended to be exhaustive, and may be used in whole or in part in this step.

The system can also load configure these SELF survey questions. For example, the system might select a reduced set of habit questions, from the 65 habit-related questions listed earlier, and use the liberated SELF survey questionnaire slots to obtains data on other key variables that could improve the diagnosis of the ego network sociometry. A sample set of 30 additional questions topics is listed in Table 3:

TABLE 3

| | | | |
|---|---|---|---|
| 1 | TEAM WORK | Leader's Style | Describe the group-working style of your group |
| | STYLES | | leader in this group |
| 2 | TEAM WORK | Teammate's Styles | Describe the predominant group-working style of |
| | STYLES | | your colleagues (excluding the leader) of this |
| | | | group. |
| 3 | YOUR STYLE | Your Intended | Describe the group-working style you have chosen |
| | | Style | to adopt for working with this group. |
| 4 | INTERACTION OF | Group's Dynamic | Describe the general group dynamic you observe |
| | TEAM MEMBER | | when the group is working together. |
| | STYLES | | |
| 5 | MOTIVATIONAL | Feel Psychological | Describe the level of psychological safety you feel |
| | TEAM CONTEXT | Safety in Team | when you are in group-working meetings with all |
| | | Meetings and | of the group leaders and members. |
| | | Interaction | |
| 6 | MOTIVATIONAL | Team-Working | Describe your perception of the personal career |
| | TEAM CONTEXT | Will Reduce | risk or opportunities associated with being asked to |
| | | Career Risk and | work with this group. |
| | | Increase | |
| | | Advancement | |
| | | Opportunity | |
| 7 | MOTIVATIONAL | Team is | Describe the group's likely reaction if you |
| | TEAM CONTEXT | Supportive Of | proposed working together to establish |
| | | Team Working | constructive group-working ground rules and |
| | | Improvement | explicitly adopting more synergistic group- |
| | | | working habits. |
| 8 | ORGANIZATIONAL | Teaming Norms | In this workplace, whenever people are assigned to |
| | ALIGNMENT | | groups they are genuinely committed to working |
| | | | together synergistically to make 1 + 1 = 3. |
| 9 | ORGANIZATIONAL | Culture | Your group members feel comfortable in openly |
| | ALIGNMENT | | expressing their ideas and opinions without fear of |
| | | | being judged. |
| 10 | ORGANIZATIONAL | Recruiting | Your group collectively has all of the core skills |
| | ALIGNMENT | | needed to achieve your common goal. |
| 11 | ORGANIZATIONAL | Goal-Setting | Your groupmates challenge themselves to achieve |
| | ALIGNMENT | | their highest possible synergistic performance. |
| 12 | ORGANIZATIONAL | Assignments | All group members have roles where their skills |
| | ALIGNMENT | | can make meaningful contributions. |
| 13 | ORGANIZATIONAL | Job Design | Your job provides an opportunity for the growth |
| | ALIGNMENT | | and development of your core skills. |
| 14 | ORGANIZATIONAL | Rewards | Individuals who are helpful and positive |
| | ALIGNMENT | | contributors to constructive group-working |
| | | | dynamics gain superior career advancement |
| | | | opportunities. |
| 15 | ORGANIZATIONAL | Respect | All group members are valued and treated with |
| | ALIGNMENT | | respect at this workplace. |
| 16 | ORGANIZATIONAL | Work Process | Team members give you the help you need to do |
| | ALIGNMENT | | your job to the best of your ability. |
| 17 | ORGANIZATIONAL | Supervision | Your supervisor and peers on this group are |
| | ALIGNMENT | | genuinely interested in having positive, |
| | | | constructive relationships. |
| 18 | ORGANIZATIONAL | Accountability | You can rely on everyone to take responsibility for |
| | ALIGNMENT | | dependably performing their specific roles within |
| | | | the group. |
| 19 | “PROSPERITY” | Overall: | Please rate your satisfaction with the opportunity |
| | IMPACT: NET | “Prosperity” | to GET greater tangible and intangible personal |
| | BENEFIT GAINED | Improvement | benefits from being a member of this group than |
| | FROM TEAM | From Team | the work you are required to GIVE in return. |
| | WORKING | Working | |
| 20 | MOTIVATIONAL | Teammates And | In a typical month at work, how many times are |
| | NETWORK | Organization Are | you treated rudely by a colleague? |
| | CONTEXT | Respectful | |
| 21 | ASSESSMENT OF | Teammate | How likely is it that you would recommend |
| | NETWORK PARTIES | Promoter | working inn this group to a friend or a colleague? |
| 22 | ASSESSMENT OF | Team Leader | How likely is it that you would recommend |
| | NETWORK PARTIES | Promoter | working with this group's leader to a friend or a |
| | | | colleague? |
| 23 | ASSESSMENT OF | Organization | How likely is it that you would recommend this |
| | NETWORK PARTIES | Promoter | organization as a place to work to a friend or a |
| | | | colleague? |
| 24 | RELATIONSHIP | Committed To | All of our group members are committed to |
| | HABITS OF | Team-Working | working together for maximum collective group |
| | NETWORK | | success and benefit. |
| 25 | RELATIONSHIP | Utilize Combined | Our group is effective at organizing it's collective |
| | HABITS OF | Effectiveness | capabilities for greater combined effectiveness and |
| | NETWORK | | maximum joint synergy generation. |
| 26 | RELATIONSHIP | Develop and | Our group is focused on properly using and |
| | HABITS OF | Utilize All Team | developing the unique skills of every member of |
| | NETWORK | Skills | our diverse group. |
| 27 | RELATIONSHIP | Improve | We are all willing to unselfishly help our |
| | HABITS OF | Performance by | groupmates in whatever ways they need to |
| | NETWORK | Helping Others | maximize their contributions to our performance. |
| 28 | RELATIONSHIP | Productive Team | Your group members have positive interpersonal |
| | HABITS OF | Member | relationships and dependably co-operative group |
| | NETWORK | Dynamics | member dynamics. |
| 29 | NETWORK'S | Team is Achieving | Our group is currently achieving the highest |
| | PERFORMANCE | Full Potential | possible beneficial outcomes for our employer, our |
| | OUTCOMES | Outcomes | key group stakeholders and all of our group |
| | | | members. |
| 30 | FLOURISHING | Overall | Taking all things together, how happy would you |
| | | | say you are with your work in this group? |

The answers to these types of self-survey questions can provide important added information on the other factors impacting the sociometric dynamics of the network. As shown in FIGS. 17a and 17b, the causal dynamic behind the “outliers” in the simple single variable relationship chart can often be explained simply by obtaining the data on just one or two of these additional variables. For example, while one of these employees-outliers had excellent group-working habits and was making very high contributions to the group's performance, this individual measured far below the expected level of personal success predicted by their relationship habits. Further survey questioning showed that this individual was feeling under recognized and rewarded because the role they were performing in the group did not allow them to use their skills to the fullest extent. In this case, by augmenting the base one variable algorithm to add just one additional “role satisfaction” variable enabled the accurate explanation of an otherwise unexplained lower level of member success/satisfaction. This added knowledge could generate a development plan focused on making the job reassignment that was the critical barrier to significantly increasing member prosperity outcomes.

This structured learning can be used to build machine learning algorithms that can results in improved diagnostics. This further understanding of network dynamics and outcomes can result in improved plans for helping the network member achieve improved success outcomes, as discussed below.

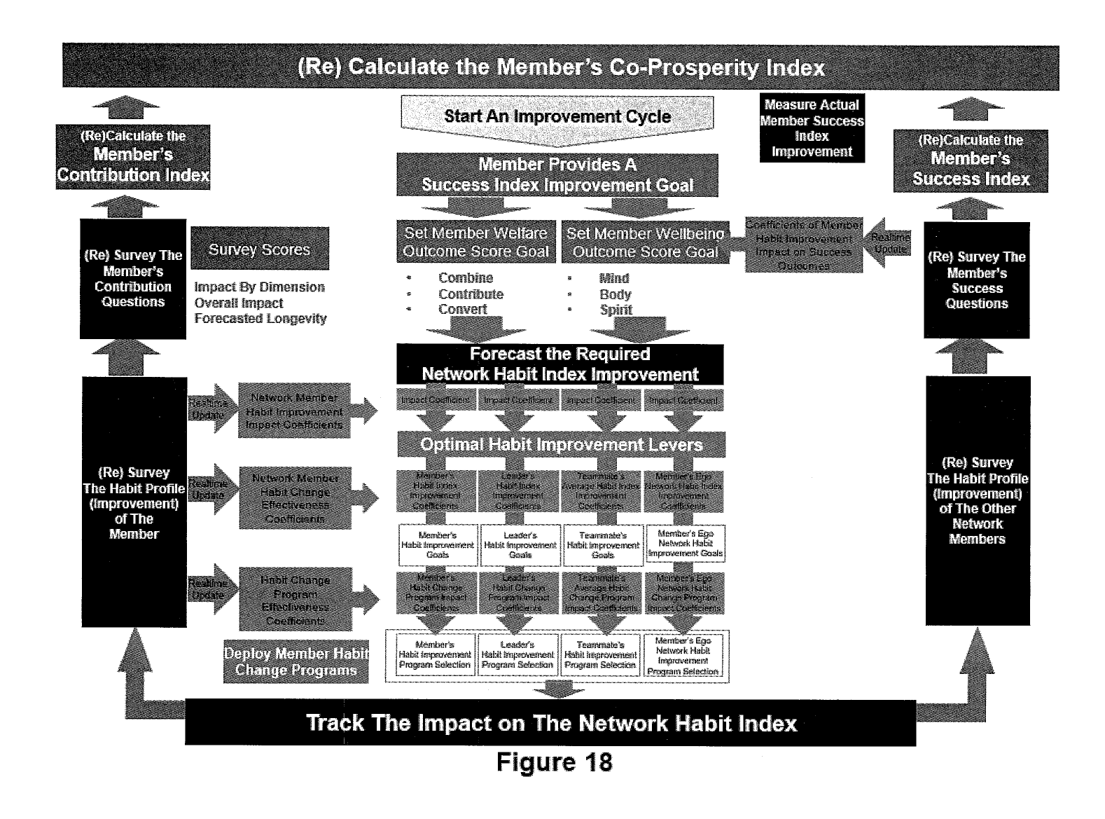

Based on the calculated indices and the analysis above, a plan can be developed to aid in the improvement of success outcomes of the network. FIG. 18 summarizes the flowchart of operations conducted by the expert system to continuously improve the member's Co-Prosperity Index outcomes by assisting the member in achieving the needed relationship habit and other group-working improvements.

As shown in this figure, the member can set at least one, and preferably a plurality of varying types of network prosperity improvement goals. These goals can be expressed as an improvement of the Member Success Index and/or the member Co-Prosperity Index. The goal can be determined by the network member or can be set or suggested by the system. For example, the member could ask to set a goal of achieving a Member Success Index level equal to the top quartile or decile, for example, of their peers. The system can ensure the selected goal is feasible based on examining the comparable of other individuals in the same or similar networks.

By knowing the various Impact Coefficients, the system can determine the habit index improvements of the network member, network peer, network leader (and broader organization if any) that would be needed to achieve the targeted increase in the Member Success Index or Co-Prosperity Index. For example, assume the Impact Coefficients were equally weighted on the habit indices of the network member, network peer, network leader and the contextual broader network (such as an organization) if any within which the network resides or is affiliated, and the system knows the current Habit Indices of each party: 25, 75, 25 and 75 respectively. In this situation the member's current Network Habit Index based on network member's Habit Indices (MHI) would be calculated in the following manner:

Network Habit Index=0.25(Member HI)+0.25(Peer HI)+0.25(Leader HI)+0.25(Org. HI)

In this case, the NHI would equal 50 if the individual Habit Indices are 25, 75, 25 and 75 respectively. So if the member set a goal of increasing their Member Success Index to 75, the system would use the correlation between the Member Success Index and the Network Habit Index to determine the Network Habit Index improvement required to achieve the member's desired Success Index goal. Assume in this example the members wanted to increase their Success Index to 75 and also that there was a 1:1 predictive relationship between the two Indices. This means the Network Habit Index would need to increase to 75 in order to enable the member to achieve their Success Index improvement goal. With this requirement quantified, then the system can help the member make the choice regarding how best to achieve this Network Habit Index improvement. For example, the system can calculate that even if the member was to increase their own Member Habit Index to 100 it would only be expected to increase the Network Habit Index only to 69. So the system would be able to forecast that this dramatic habit change by the member alone In this way, the system can look at each of these improvement options and find the most feasible member success improvement plan. The system will identify these various improvement options using a real-time database of the Success Indices and Habit Indices data for comparable or related networks and corresponding types of members.

Once a specific Habit Index improvement goal is selected, the system can then identify the specific habit changes to pursue in trying to achieve the desired Habit Index increase.

Once the degree of habit change that is required or desired is known and the list of potential contributing habit changes is identified the system can also determine the habit changes that are most likely to be of highest impact. This is done by:
Establishing what degree of habit score improvement is likely based on examining the current habit scores of other members already achieving higher Habit Index. (For example, the system would know based on the extensive habit score database that achieving a perfect score of 10 is unlikely in certain categories.)
Examining the level of improvements being achieved when the available habit change interventions have been applied to similar network members. Habit improvement is harder in some categories than others. So the habit changes which are most likely achievable can be determined by examining each option against a real-time database of the current marginal effectiveness of the available habit change program options.

By examining this habit change data, the various options can be identified and the habit improvement plan with the greatest likelihood of success can be identified in some embodiments through scenario modeling.

A specific final habit improvement program to be presented to the member can be selected by referring to the inventory of available habit improvement interventions contained in a compiled database of program options. These habit improvement program interventions can include educational content, skill training, learning games, etc. The statistics in this database on the prior marginal effectiveness of various habit improvement interventions in similar situations can be used in an optimization model to identify the habit improvement programs with the greatest likelihood for success. For example, if this member were an older male, certain of the habit change program options commonly used with millennials might not be shown (via tracking of the pre-post training program habit improvement of similar individuals) to have been as effective as others. This data enables the ranking of available programs to identify the ones most likely to be effective in creating the desired habit change with the member.

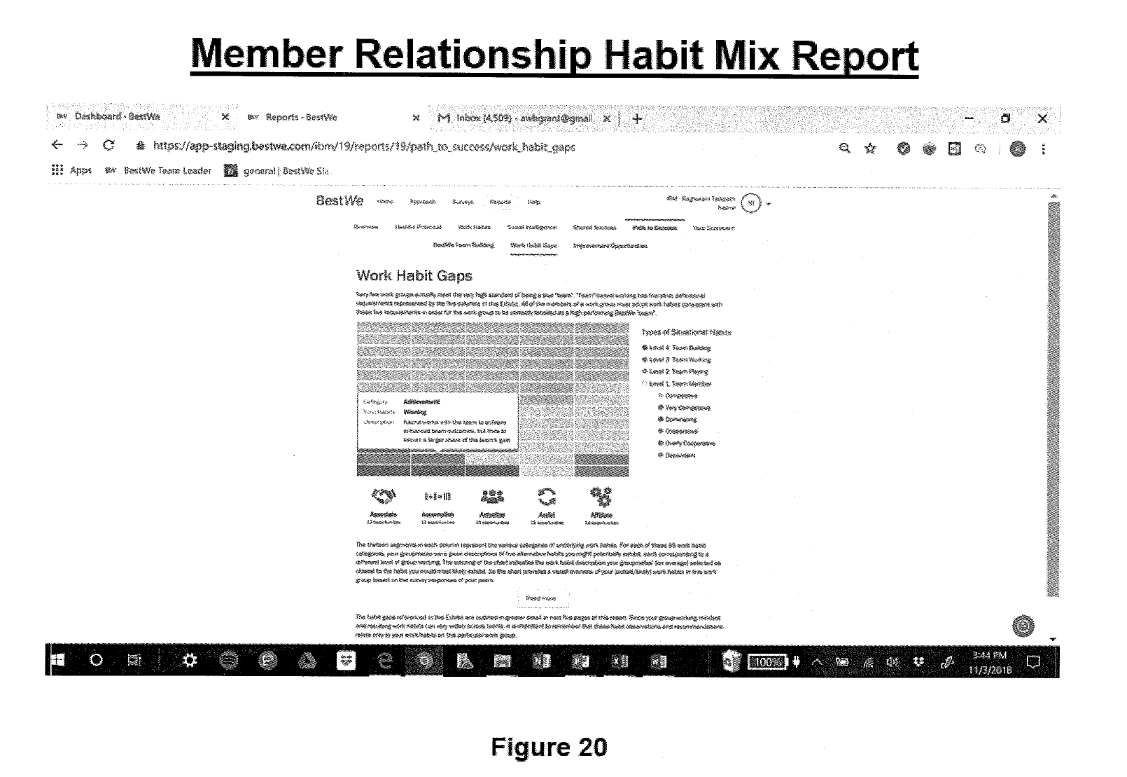

In some embodiments, a personalized report summarizing the network assessment findings can be provided to the member which can detail their path to success. This report can start with an index of contents spanning the information on the various aspects of the network performance as outlined above as shown in FIG. 19. This is an Index to the contents of one example of such a report. In going through the contents of this report the user sees a summary of which habits were selected by the user's peers in their surveys as representing the user's most common relationship habits. This Habit Profile is shown on FIG. 20. It is a sample area chart showing the current habit mix of a network member. It identifies visually (using non-blue shading) the current habits that would need to be changed to improve the member's success outcomes.

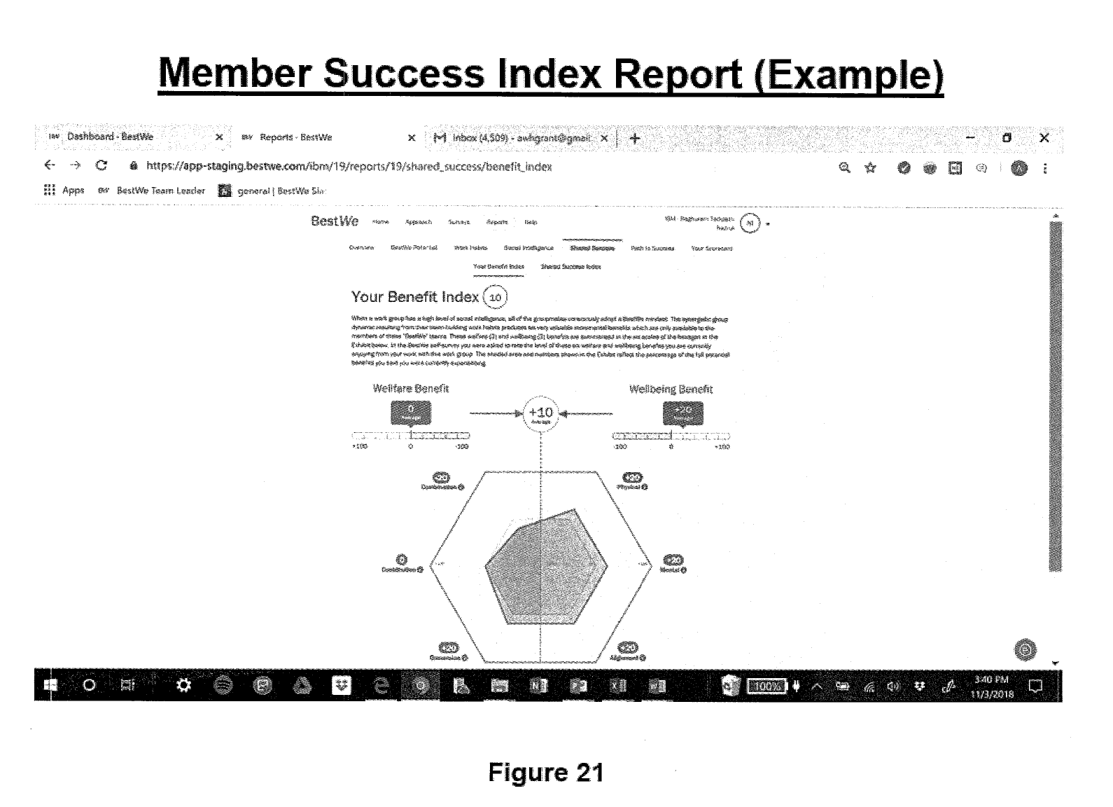

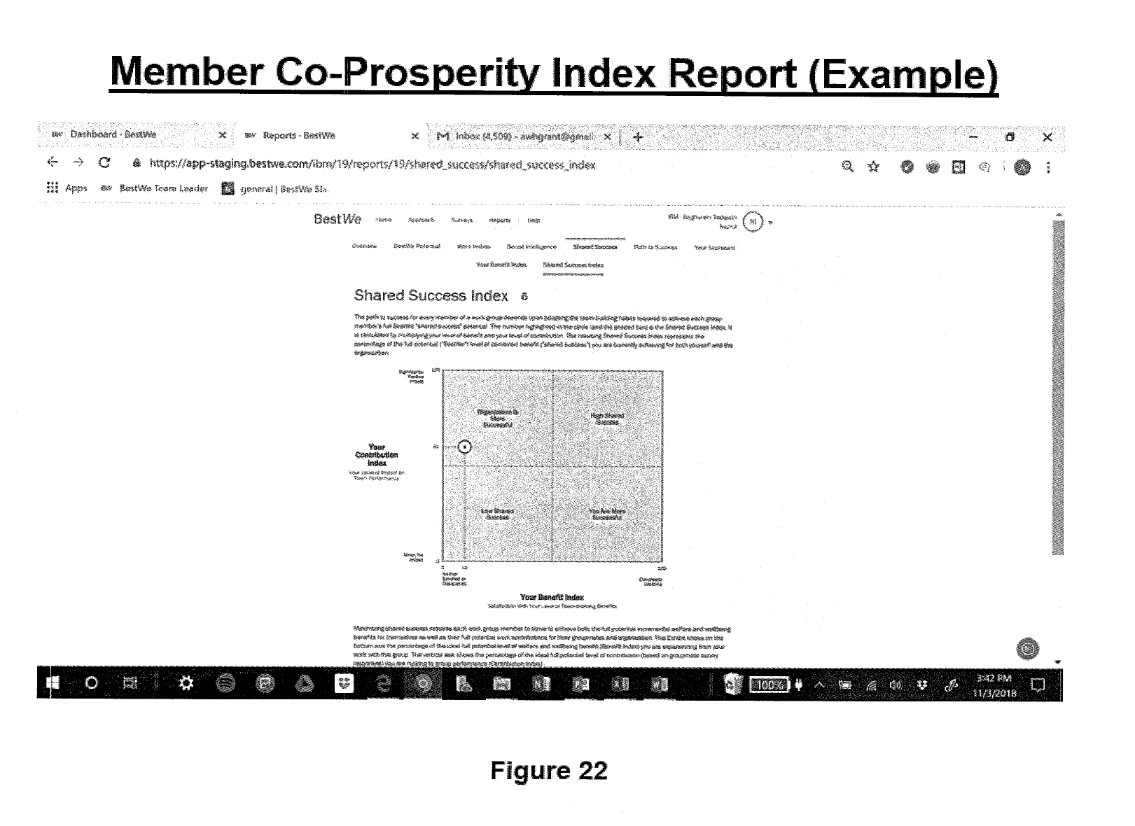

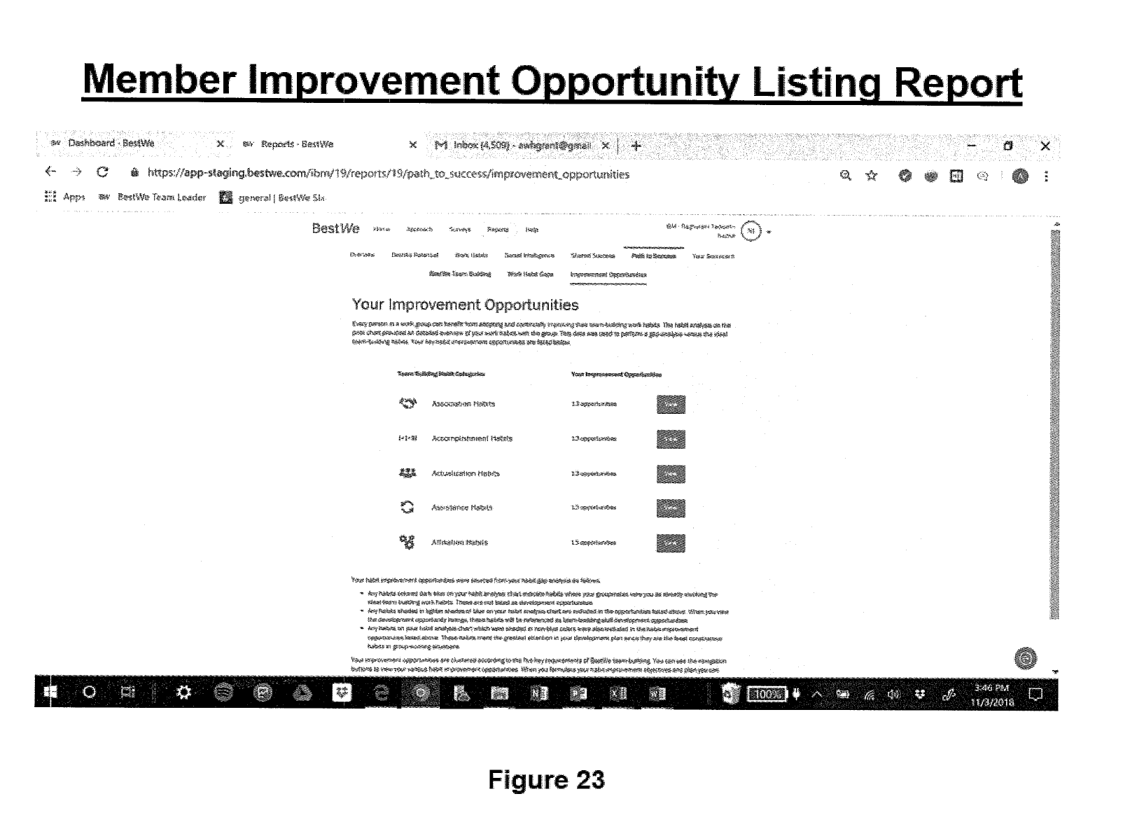

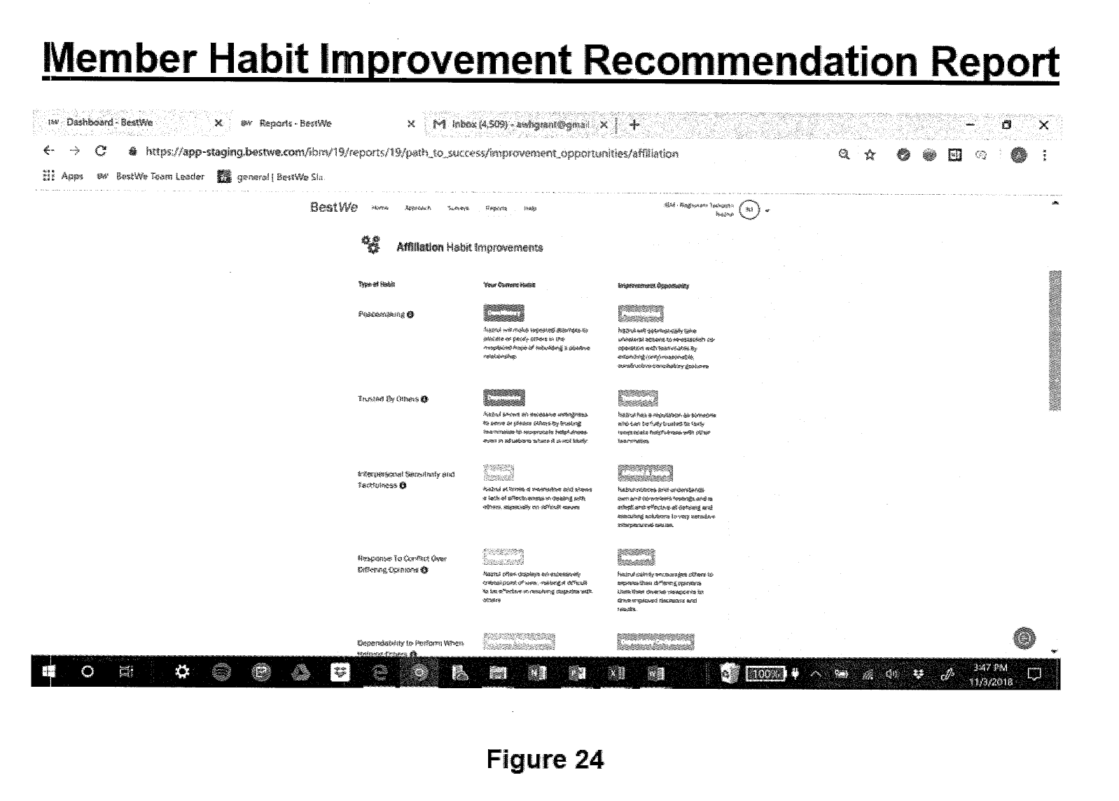

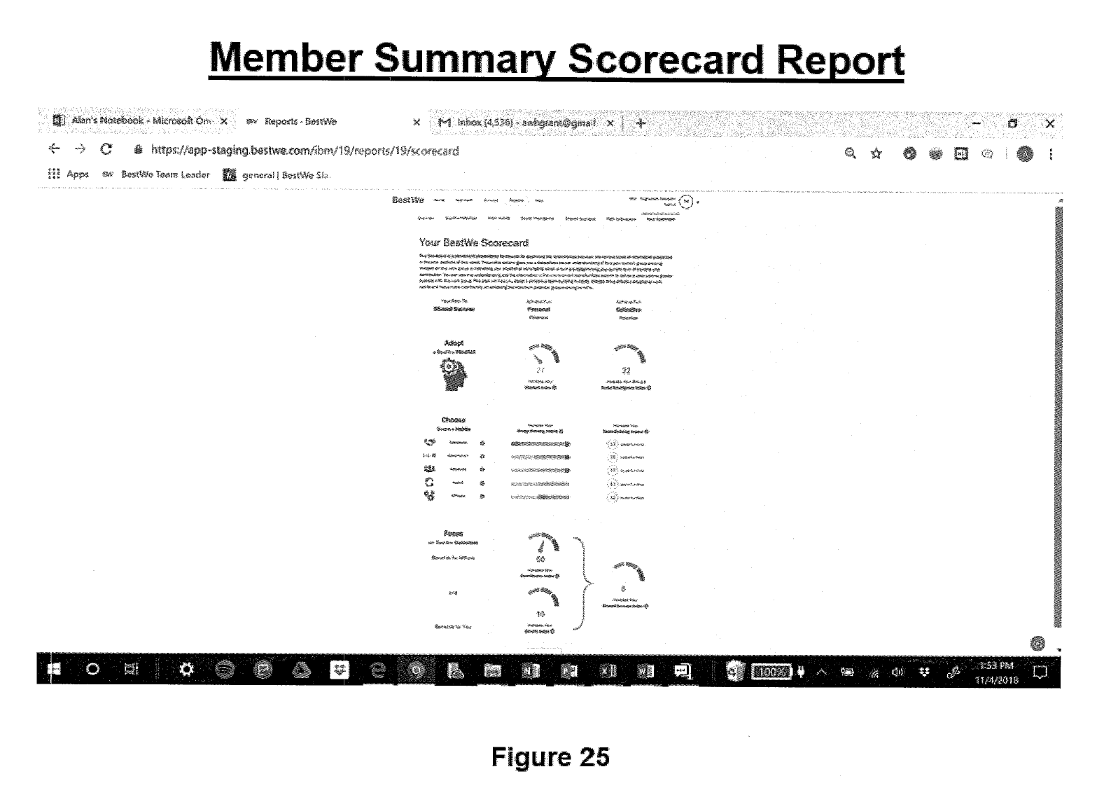

The report can give each member a summary of their Member Success Index, which may preferably be shown graphically, as shown in FIG. 21. The report can provide the details of the calculation of the member's Co-Prosperity Index as shown in FIG. 22. The report can give each member a detailed overview of the selected core group-working habit improvement areas as shown in FIG. 23 and it can provide a summary listings of their various required habit improvement actions (based on the gaps from the ideal profile) as shown in FIG. 24. For each improvement area, the report can provide a high-level summary of the required habit improvement. Finally, as shown in FIG. 25 the report also provides the user with a consolidated overview of the assessment provided by the expert system by providing a summary scorecard recapping the results in each area covered previously.

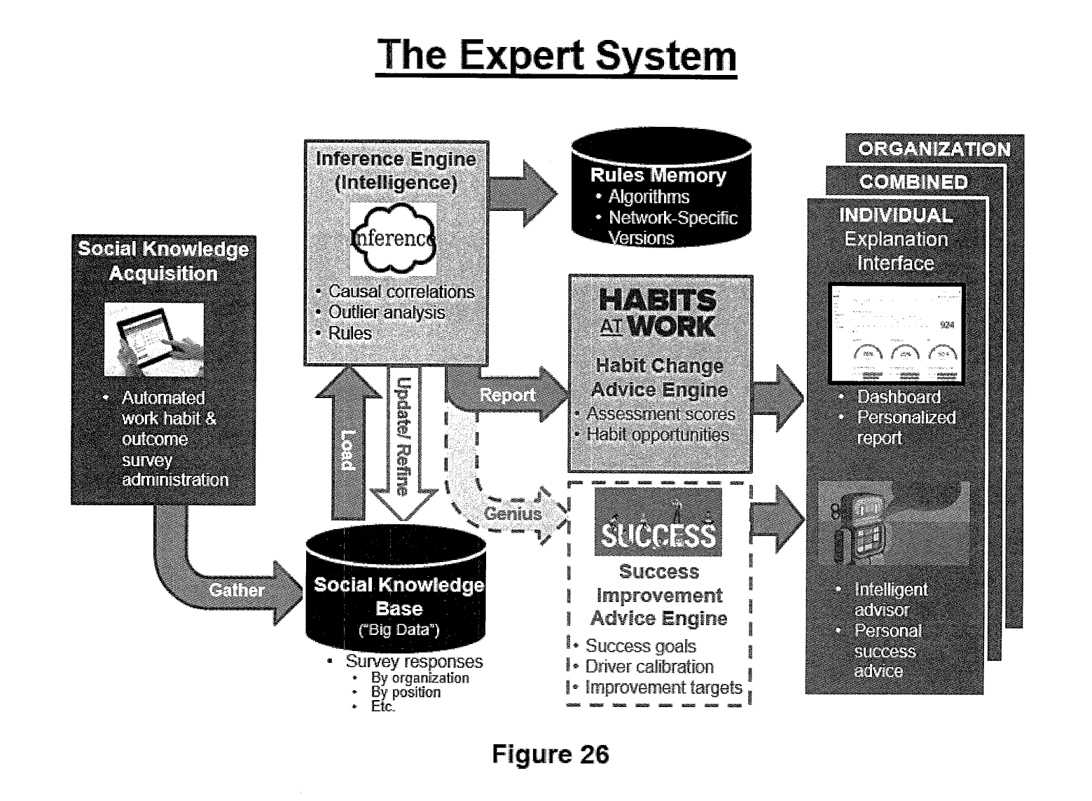

FIG. 26 provides a schematic representation of one embodiment of a supporting expert system. This system, like most conventional AI expert systems, comprises three core components: a KNOWLEDGE BASE, INFERENCE ENGINE and EXPLANATION INTERFACE.

The KNOWLEDGE BASE may be populated by the ego network member self-assessment survey scores and peer habit assessment survey scores. When group members complete online assessment survey instruments, for themselves and for other group members, they provide the habit profiling data needed to classify team members into distinct group-working style categories. This classification data can be used to develop the member habit index, which aggregates and summarizes the predominant habits of each individual member of the network.

By using the data on the collective relationship habits of the combined network, the overall network can also be assigned a network habit index, which may be a specific numerical score reflective of the level of social intelligence of the network as manifest in the predominant group-working style of the network. When habit indices are statistically correlated to an index of the member's Co-prosperity Index, these key indices are also retained in the knowledge base. When multivariate analysis of the network member habit and prosperity indices is conducted to calibrate the exact positive underlying quantitative relationship between the observed relationship habit profiles of the network members and the resulting member co-prosperity outcomes, this data is also stored in the knowledge base. When correlations are conducted at a relationship behavior level to calibrate how specific relationship habits impact shared success outcomes, these key analytic results are also stored in the knowledge base. All of this knowledge base data provides the detailed understanding of network dynamics and outcomes needed to inform the expert advice as to the most high-impact habit improvements.

The system further comprises an INFERENCE ENGINE. The inference engine described herein can diagnose the network social dynamics by determining the causal relationships between the MHI of a network member (and the overall Network Habit Index) and the co-prosperity outcomes being experienced by the network members. This can be done by calculating empirically validated correlations between the two data sets. The resulting correlation coefficients in these causal relationships can be used to inform the automated identification of the habit change advice which is most likely to produce the largest improvement in the shared success outcomes. The inference engine gains progressively deeper insights from the analysis of the expanding set of data in the knowledge base. More specifically, the inference engine can predict with increasing accuracy the co-prosperity impact of various types of member and network habit improvements by constantly refining the correlations between the MHIs, the NHIs, the SIs and the CPIs.

When the engine identifies statistical outliers to the most recent habit-success correlations it analyzes the data in the knowledge base to determine the likely drivers of these outliers to the most recent expected multivariate correlations. This process continually identifies the additional contextual factors that are impacting the Success Indices and/or the CPIs. The system can then add these added factors as additional variables in the next multivariate analysis. This results in a continuously-improving empirically validated understanding of the full interrelated impacts between the shared success of the network members and the multiple underlying factors driving CPI. As more networks provide their habit profile and success outcome survey data to the knowledge base, even more in-depth causal relationships are revealed between the underlying factors or combinations of factors which drive the social dynamics and shared success outcomes of the network. The system can replicate this dynamic deep learning process on each specific type of network: workplace teams of various levels/types, marriages, families, etc. By building this causal understanding of the relationship between member habits and shared success outcomes for each type of network, the system can predict even more accurately the likely increase in shared success to be gained by achieving varying levels of network habit improvements.

A user EXPLANATION INTERFACE provides the capability needed to deliver 1:1 diagnosis, advice and habit improvement programs to a member (the system user). The explanation interface uses the identified habit improvement levers generated from the inference engine to configure and deliver personalized development plans to each user. In some instances, these plans may be delivered in the form of an in-depth, custom-configured written report providing the appropriate personalized coaching content. In other deployments this coaching and content can be delivered to each member in a more interactive manner by using an automated software agent (“bot”). In any case, members receive the details of the plan and associated content on a confidential basis. The personalized advice may comprise improvements in the member's overall relationship style as well as more detailed advice concerning specific relationship habit improvement opportunities. For example, one user may be advised to improve their listening habits while another may be advised to refine their dispute resolution habits.

The habit change recommendation is also supported by habit adoption advice. This adoption advice may comprise at least one of an inventory of habit improvement interventions, which can include educational content, skill training, learning games, etc. The observed effectiveness or impact of these various habit improvement interventions in actually achieving the targeted habit change can be measured over time in one ego network, or across all ego networks, to understand their relative effectiveness in closing different types of individual habit gaps. This real-time knowledge of the relative prosperity improvement effectiveness of each habit adoption program can be used to enable the automated selection (for any specific ego) of the optimal habit improvement interventions contained across the whole inventory of alternative habit improvement options.

The system may also include automated event-based triggers needed to track the user's habit improvement. These triggers ensure the system makes appropriate contact with the network member and his/her network peers to ask the follow-up habit and prosperity outcome questions needed to measure and track the prosperity impact of the habit change programs. The delivery of this 1:1 coaching provides the user an augmented level of social intelligence. The structured learning capability in the inference engine provides this explanation interface with personalized 1:1 prosperity/success improvement plans that may be more effective than traditional relationship skill-building education programs or human performance coaching.

The network ego member (and other network members as requested) can be advanced along a pathway to greater co-prosperity by continually analyzing and improving their MHI and network habit index. This “always on” capability can continuously monitor the habit gaps of the network ego and other members and the relative effectiveness of all of the available habit improvement interventions. Machine learning tools can be used to examine a real time database and automate the identification and delivery of the optimal ongoing habit improvement interventions that are required to continuously improve the welfare and wellbeing of each individual.

The impacts of the interventions by the system can be tracked by examining the network member habit and success level improvements observed in the subsequent tracking surveys administered to each network member. Any variance from the expected impact predicted when developing the interventions can be used to develop updated Impact Coefficients. These enhanced predictive models can be used to update/improve all of the coefficients used in each of the decision-making steps for subsequent corrective habit improvement action plans. This structured learning loop can be used to continuously improve the effectiveness of the expert system platform.

The impact created by the network member's habit changes on the Success Indices of all of the other members of the network can also be measured and tracked. A similar structured learning process can also be followed to enhance the accuracy of the predictions of likely impacts of various network-wide habit improvement initiatives with the greatest impacts on all network members

Machine learning and automated campaign management tools can be used to create an automated continuous improvement loop where the system deliver a stream of optimized interventions to the network member based on their likely relative effectiveness in improving the co-prosperity of the member.

In some embodiments, the system can provide member social networking within and across networks. Members can register additional networks within their overall ego network. The members of these networks can progress through the same steps outlined above. Members can also publicize their progress to other members of their ego network and beyond by opening the visibility of their account to others so that these other parties can see their Habit and Success Indices. The various members of their ego network can also have the functionalities needed to share messages, content, chat in this user forum. Third party referrals to service providers (such as psychologists, performance coaches etc.) who are qualified to provide more in-depth advice and counselling on specific habit change challenges can also be provided via the platform.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments described herein.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the embodiments described herein. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Btu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

1. A method for analyzing, improving, and monitoring the co-prosperity of members of a network, an ego network, a subnetwork or affiliated networks, comprising the steps of: for each member, profiling the habits of the member and determining a member habit index; profiling the welfare and wellbeing of the member and determining a member success index; determining a co-prosperity index for the member reflecting the member's benefits from and contributions to the network; determining the causal relationships between the member and network relationship habit profiles and the co-prosperity index of the member; developing and delivering a habit improvement program to the member based on the predictive modelling of the impact of changes to the member habit profile and the member welfare and wellbeing outcomes.

2. The method of claim 1 further comprising the step of tracking the effectiveness of the habit improvement program by periodically updating the habit profile of the member and the welfare and wellbeing profile of the member.

3. The method of claim 1 wherein the step of profiling the habits of a member comprise the steps of compiling results from a self-survey from the member and surveys of other members regarding the member's relationship habits.

4. The method of claim 3 wherein the member's relationship habits are characterized as being dependent, independent or interdependent.

5. The method of claim 3 wherein any survey for any selected member may be shortened or simplified based on prior survey results or previously determined causal relationship.

6. The method of claim 1 wherein the development and delivery of a habit improvement program is implemented with an automated software agent.

7. The method of claim 1 wherein the method comprises the further step of modifying the causal relationships between the member and network relationship habit profiles and the co-prosperity index of the member based on the identification of at least outlier and at least one additional variable which at least partly explains the outlier.

8. A method of improving a co-prosperity index of a member or a plurality of members in a network, comprising the steps of: determining a member's contribution index and a member's success index; determining a member contribution index goal and/or a success index goal; predicting at least one habit improvement required for each of the network members in order to progress towards one or both goals, by identifying at least one member or network habit improvement known to causally drive the co-prosperity outcome for the member; and implementing the network habit improvement with the member.

9. The method of claim 8 comprising the further step of repeating some or all of the steps if the member has not achieved either or both the success index goal or the contribution index goal.

10. A computer system for analyzing, improving, and monitoring the co-prosperity of an ego network having a plurality of members, or a group of affiliated ego networks, the computer system including at least one processor; at least one computer-readable storage medium operatively coupled to the at least one processor and comprising representation of at least one set of computer instructions that, when executed by said processor, causes the computer system to perform the operations of: for each member, profiling the habits of the member and determining a member habit index; profiling the welfare and wellbeing of the member and determining a member success index; determining a co-prosperity index for the member reflecting the member's benefits from and contributions to the network; determining the causal relationships between the member and network relationship habit profiles and the co-prosperity index of the member; developing and delivering a habit improvement program to the member based on the predictive modelling of the impact of changes to the member habit profile and the member welfare and wellbeing outcomes.

11. The system of claim 8 wherein the system further performs the operation of tracking the effectiveness of the habit improvement program by periodically updating the habit profile of the member and the welfare and wellbeing profile of the member.

12. The system of claim 7 wherein the operations include a method as claimed in any one of claims 1-9.
